(19) United States
(12) Patent Application Publication
(10) Pub. No.: US 2010/0030896 A1
(43) Pub. Date: Feb. 4, 2010

(54) ESTIMATING LATENCIES FOR QUERY OPTIMIZATION IN DISTRIBUTED STREAM PROCESSING

(75) Inventors: Badrish Chandramouli, Bellevue, WA (US); Jonathan Goldstein, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/573,108

(22) Filed: Oct. 3, 2009

Related U.S. Application Data
(63) Continuation-in-part of application No. 12/141,914, filed on Jun. 19, 2008.

(51) Int. Cl. G06F 15/173

(52) U.S. Cl. 709/224; 709/226

(57) ABSTRACT

A “Query Optimizer” provides a cost estimation metric referred to as “Maximum Accumulated Overload” (MAO). MAO is approximately equivalent to maximum system latency in a data stream management system (DSMS). Consequently, MAO is directly relevant for use in optimizing latencies in real-time streaming applications running multiple continuous queries (CQs) over high data-rate event sources. In various embodiments, the Query Optimizer computes MAO given knowledge of original operator statistics, including “operator selectivity” and “cycles/event” in combination with an expected event arrival workload. Beyond use in query optimization to minimize worst-case latency, MAO is useful for addressing problems including admission control, system provisioning, user latency reporting, operator placements (in a multi-node environment), etc. In addition, MAO, as a surrogate for worst-case latency, is generally applicable beyond streaming systems, to any queue-based workflow system with control over the scheduling strategy.

### CROSS-REFERENCE TO RELATED APPLICATIONS

This application is a Continuation-In-Part of, and claims priority to, U.S. patent application Ser. No. 12/141,914, filed on Jun. 19, 2008 by Jonathan D. Goldstein, et al., and entitled “STREAMING OPERATOR PLACEMENT FOR DISTRIBUTED STREAM PROCESSING”, the subject matter of which is incorporated herein by this reference.

### BACKGROUND

1. Technical Field

A “Query Optimizer,” as described herein, provides a cost estimation metric, referred to as “Maximum Accumulated Overload” (MAO), which is approximately equivalent to worst-case latency for use in addressing problems such as, for example, minimizing worst-case system latency, operator placement, provisioning, admission control, user reporting, etc., in a data stream management system (DSMS).

2. Related Art

As is well known to those skilled in the art, query optimization is generally considered an important component in a typical DSMS. Ideally, actual system latencies would be used in query optimization. However, actual worst-case latencies can generally not be measured in sufficient time to be of use in a typical real-time DSMS system that may operate with very large numbers of users in combination with large numbers of continuous queries (CQs). Consequently, many conventional cost measures have been proposed for use with DSMS, including, for example, resource usage, output rate, resiliency, load correlation, simulated load, network usage and communication latency, etc. However, these types of conventional solutions do not directly optimize for worst-case latency. As a result, overall system performance may not be optimal.

More specifically, many established and emerging applications can be naturally modeled using event streams. Examples include monitoring of networks and computing systems, sensor networks, supply chain management and inventory tracking based on RFID tags, real-time delivery of Web advertisements, etc. In general, users of such applications register CQs with the DSMS. CQs typically run on a DSMS for long periods (e.g., weeks or months) and continuously produce incremental output for newly arriving input stream events. In typical streaming applications, users expect real-time results from their queries, even if the incoming streams have very high arrival rates (e.g., many concurrent users or other input sources with large numbers of CQs).

Similar to traditional database queries, a CQ is often specified declaratively using an appropriate conventional surface language such as StreamSQL, LINQ, Esper EPL, etc. The CQ is then converted by the DSMS into a “physical plan” which consists of multiple streaming operators (e.g., windowing operators, aggregation, join, projects, user-defined operators, etc.) connected by queues of events. Further, there may be many alternate physical plans for a CQ, with different behavior profiles depending upon any of a number of factors. In addition, in a distributed DSMS, these operators may themselves be distributed amongst the available nodes (i.e., individual computing machines such as server computers) in different ways.

There are a number of problems that are typically addressed, with varying levels of success, in conventional streaming systems (e.g., Oracle™, Streambase™, etc). For example, in the problem of “stream query optimization,” for a given set of CQs, the DSMS seeks to find the best physical plans and/or assignment of operators to nodes to minimize overall latency. A closely related problem is re-optimization, which is the periodic adjustment of the CQs based on detected changes in overall input behaviors. The problem of “admission control” involves attempts to add or remove a CQ from the system, where the DSMS needs to quickly and accurately estimate the corresponding impact on the system. The problem of “system provisioning” arises when a system administrator needs to be able to determine the effect of making more or fewer CPU cycles or nodes available to the DSMS under its current CQ load. Finally, the problem of “user reporting” arises since it is often useful to provide end users with a meaningful estimate of the behavior of their CQs, with such estimates also being useful as a basis for guarantees on performance and expectations from the overall system.

In a real-time DSMS, a common user requirement for most applications is low latency, i.e., the time between when an input event enters the DSMS and when its effect is delivered to the consumer. Thus, latency is a good starting point to solve each of the above problems. Typically, users are interested in quantiles or data points such as worst-case latencies, average latency, 99.9^{th} percentile of latency, etc. Unfortunately, it is very difficult to estimate actual response times and latencies for use in a cost model in a large distributed DSMS with complex moving parts and non-trivial system interactions that are difficult to model accurately. As such, actual or near real-time latency information is not available for use in configuring or optimizing conventional DSMS. Finally, the ability of a modern DSMS to support multiple CQs means that the decision of whether to allow a new query is crucial, since it could violate the real-time constraints of existing queries.

In related fields, multimedia object scheduling, which requires packing of sequences with timing and disk bandwidth constraints, has similarities to operator placement in a DSMS. However, the challenge there is to find start time slots for a given set of expensive jobs, such that the end time of the last job is minimized. Consequently, while there are some similarities, techniques developed for multimedia object scheduling are generally not well suited for use in a typical DSMS.

Queuing theory has provided valuable insights into scheduling decisions in multi-operator and multi-resource queuing systems. Unfortunately, the results of such schemes are typically limited by high computational cost and strong assumptions about underlying data and processing cost distributions.

Traditionally, query optimization in databases is a well-studied problem. In addition, there have been studies on load balancing in traditional distributed and parallel systems. Unfortunately, these techniques do not directly apply to stream processing, since typical queries are long running or “continuous” in the case of CQs. Further, the per-tuple load balancing decisions used by such systems for addressing disk I/O bottlenecks are generally too costly for use in optimizing long running queries in a typical DSMS.

Scheduling is another well-studied problem for streaming systems. Various scheduling algorithms with different goals have been developed. Some of these algorithms have an effect of improving latency. In contrast, CPU scheduling in real-time databases is related, but deals with a different scenario and does not focus on worst-case latency. Finally, Quality of Service (QoS)-aware load shedding for streams has been proposed in at least one conventional system to provide a control-based approach for handling QoS using adaptation and admission control.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “Query Optimizer,” as described herein, provides various techniques for computing a cost estimation metric, referred to herein as “Maximum Accumulated Overload” (MAO), which is approximately equivalent to worst-case latency in a typical data stream management system (DSMS) for different portions of the DSMS workload experiencing different event arrival patterns. In various embodiments, the Query Optimizer computes or estimates MAO given as few parameters as knowledge of original operator statistics, including operator selectivity and cycles/event, and an expected event arrival workload. As such, the MAO can be pre-computed (or periodically re-computed) for use in a variety of latency-based optimization operations in a typical DSMS. Note that the term “operator,” as discussed throughout this document, refers to operators of continuous queries (CQs) and does not refer to a human user that may be operating various machines or software.

For example, the automatically computed MAO metric is useful for addressing a number of problems such as query optimization, provisioning, admission control, and user reporting in a DSMS. Further, in contrast to conventional queuing theory, the Query Optimizer makes no assumptions about joint load distribution in order to provide operator placement solutions (in the case of a multi-node setting) that are both lightweight and tunable to a given optimization budget.

More specifically, in various embodiments, the Query Optimizer provides an end-to-end cost estimation technique for a DSMS that produces a metric (i.e., MAO) which is approximately equivalent to maximum or worst-case latency. The techniques provided by the Query Optimizer are easy to incorporate into a conventional DSMS, and can serve as the underlying cost framework for stream query optimization (i.e., physical plan selection and operator placement). Further, the Query Optimizer uses a very small number of input parameters and can provide estimates for an unseen number of nodes and CPU capacities, making it well suited as a basis for performing system provisioning. In addition, MAO's approximate equivalence to latency allows MAO to be used for admission control based on latency constraints, as well as for user reporting of system misbehavior.

Given the ability of the Query Optimizer to estimate latency (via the MAO metric) with high accuracy, in various embodiments, the Query Optimizer can also be used to select the best physical plan for a particular user-specified streaming query by computing operator statistics on a small portion of the actual input (on the order of about 5% or so). Further, the Query Optimizer can be used to choose the best placement (across multiple nodes), of operators in any given physical plan. For example, in various embodiments, a “hill-climbing” based operator placement algorithm uses estimates of MAO to determine good operator placements very quickly and with relatively low computational overhead, with those placements generally having lower latency than placements achieved using conventional optimization schemes. Finally, it should also be noted that the basic idea of MAO and its relation to latency is more generally applicable beyond streaming systems, to any queue-based workflow system with control over the scheduling strategy.

In view of the above summary, it is clear that the Query Optimizer described herein provides various techniques for computing a cost estimation metric, referred to herein as “Maximum Accumulated Overload” (MAO), which is approximately equivalent to worst-case latency in a typical DSMS (or other queue-based workflow system with control over the scheduling strategy). In addition to the just described benefits, other advantages of the Query Optimizer will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of the Query Optimizer for implementing MAO cost estimation capabilities within a modified data stream management system (DSMS), as described herein.

FIG. 2 provides an illustration of measured input loads over an extended time-period for click-stream data of an exemplary advertisement delivery system, as described herein.

FIG. 3 provides an example of a simple DSMS query graph with three nodes, as described herein.

FIG. 4 shows an example of node deterministic load time-series (DLTS) for each of the nodes of the DSMS query graph of FIG. 3, as described herein.

FIG. 5 shows an example of accumulated overload (AO) for each of the three nodes of the DSMS query graph of FIG. 3, as described herein.

FIG. 6 illustrates an example of the progress of an event through the operators of the DSMS query graph of FIG. 3, as described herein.

FIG. 7 illustrates a general system flow diagram that illustrates exemplary methods for implementing various embodiments of the Query Optimizer, as described herein.

FIG. 8 is a general system diagram depicting a simplified general-purpose computing device having simplified computing and I/O capabilities for use in implementing various embodiments of the Query Optimizer, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

### 1.0 Introduction:

Latency is an important factor for many real-time streaming applications. In the case of a typical data stream management system (DSMS), latency can be viewed as an additional delay introduced by the system due to time spent by events waiting in queues and being processed by query operators. Ideally, query operators generate outputs at the earliest possible time, thereby reducing system latencies. Unfortunately, worst-case latencies can generally not be measured in sufficient time to be of use in a typical real-time DSMS that may operate in a dynamic environment with very large numbers of users in combination with large numbers of continuous queries (CQs), also referred to herein as “streaming queries”. However, a “Query Optimizer,” as described herein, provides various techniques for quickly computing or even pre-computing a cost estimation metric, referred to herein as “Maximum Accumulated Overload” (MAO) for use in optimizing a typical DSMS.

In general, MAO is approximately equivalent to worst-case latency in a typical DSMS. In fact, the estimated MAO computed by the Query Optimizer has been observed to be accurate to within approximately 4% of worst-case system latency in a typical DSMS. Further, MAO at any time t closely corresponds to the maximum latency at time t, which allows the Query Optimizer to estimate latency beyond worst-case, including averages and quantiles (e.g., 99^{th} percentile) of maximum latency.

As noted above, the worst-case MAO metric, referred to herein as MAO_{wc}, computed by the Query Optimizer is approximately equivalent to maximum or worst-case system latency in a DSMS. Consequently, MAO is useful in a variety of real-time streaming applications for running multiple continuous queries (CQs) over high data-rate event sources (e.g., thousands or millions of users concurrently accessing a web page and clicking on various links). In various embodiments, the Query Optimizer computes MAO given as little information as knowledge of original operator statistics (e.g., operator selectivity and cycles/event as discussed in further detail below) and an expected event arrival workload (either modeled or based on statistical evaluations of prior workload histories). Consequently, the MAO can be pre-computed (or periodically re-computed) for use in a variety of latency-based optimization operations in a typical DSMS.

Beyond meaningful cost-based query optimization to minimize worst-case latency, MAO is also useful for addressing a variety of problems in a DSMS including, for example, admission control, system provisioning, user latency reporting, etc. In addition, MAO, as a surrogate for worst-case latency, is generally applicable beyond streaming systems to any queue-based workflow system with control over the scheduling strategy.

The following discussion and examples provide general definitions of several of the terms used throughout this specification. For example, assume that the user issues a query, where a query can be defined as a high level logical and declarative representation of what the user wants. A simple example of such a query is “Alert me when the price of XYZ stock changes by more than $1 between two consecutive price readings.”
a. Select XYZ stock, then perform a self-join to detect price changes;
b. Perform a self-join to detect price change of the same stock, then select only price-changes that correspond to XYZ stock;
c. Select XYZ stock, then use a pattern-matching operator to detect the price change;
d. Etc.

Given a particular physical plan, operator placement is the actual assignment of operators in the chosen physical plan, to nodes/machines in a cluster of nodes. For example, “assign the ‘stock select’ operator to machine A, and the ‘join operator’ to machine B”. In general, the plan selection component of the Query Optimizer chooses the best physical plan (not operator placement) by:
a. Iterating through various possible plans in the plan space (i.e., the set of possible plans to address the query). This iteration can be addressed using exhaustive enumeration or other conventional database techniques, or can use the “hill-climbing” optimization techniques described in Section 2.7.1;
b. Deriving the necessary statistics for each such candidate physical plan;
c. Computing MAO_{wc} for each candidate physical plan assuming a single machine/node (see note below regarding clusters of nodes); and
d. Choosing the physical plan with lowest MAO_{wc}.

Once a physical plan is chosen, the Query Optimizer then determines the “best” operator placement for that physical plan (assuming multiple nodes). The operator placement component of the Query Optimizer uses the MAO-HC (hill-climbing) algorithm described in Section 2.7.1 to choose the best (i.e., lowest MAO_{wc}) assignment of operators to nodes for that physical plan. Note that in the case of a single node DSMS, operator placement is not considered since all operators are assigned or placed to that single node.

The conclusion of the above-summarized operator placement component of the Query Optimizer provides the end-result of query optimization—operators are instantiated at their corresponding nodes, logically wired together, and the query starts executing.

Note that a more computationally expensive but feasible alternative for the plan selection component of the Query Optimizer summarized above, is to directly work with an actual cluster of nodes (instead of assuming a single machine). In particular, the operator placement component of the Query Optimizer is repeatedly invoked for each potential candidate physical plan, in order to compute MAO_{wc}. In this case, the end-result of the plan selection component of the Query Optimizer would directly be the final chosen physical plan and operator placement.

1.1 System Overview:

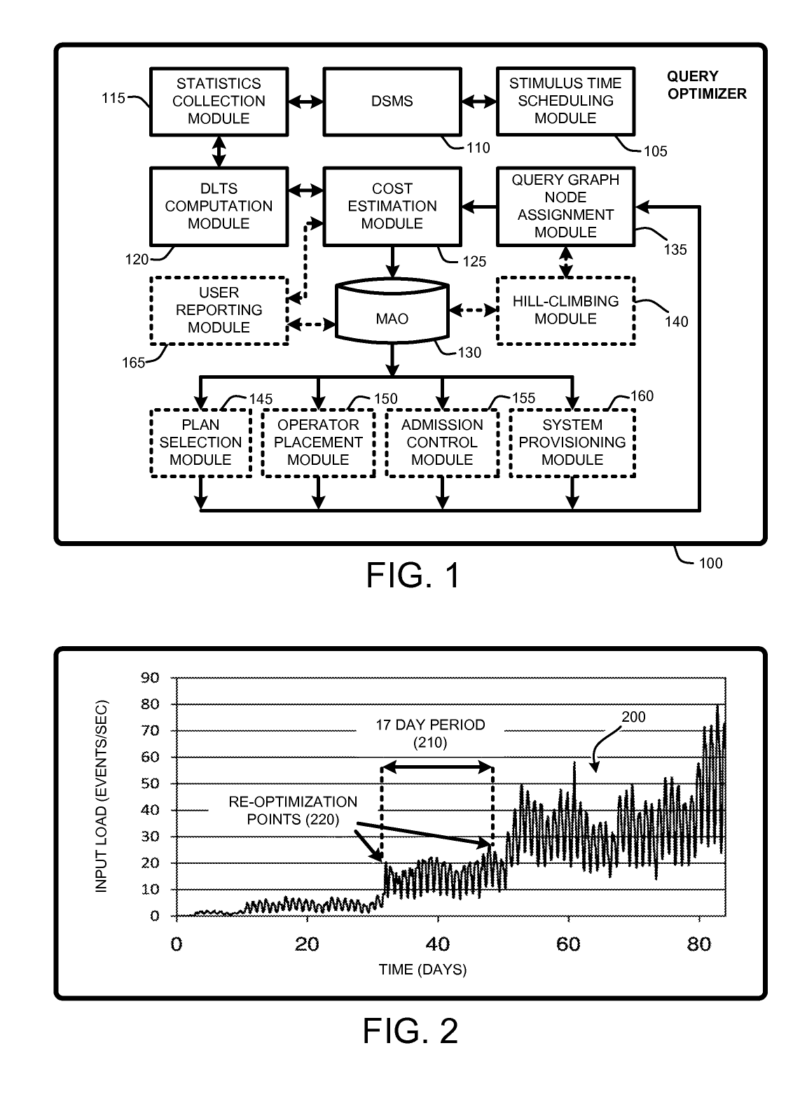

As noted above, the “Query Optimizer,” provides various techniques for computing a cost estimation metric, referred to herein as “Maximum Accumulated Overload” (MAO), which is approximately equivalent to worst-case latency in a typical DSMS. The processes summarized above are illustrated by the general system diagram of FIG. 1. In particular, the system diagram of FIG. 1 illustrates the interrelationships between program modules for implementing various embodiments of the Query Optimizer, as described herein. Furthermore, while the system diagram of FIG. 1 illustrates a high-level view of various embodiments of the Query Optimizer, FIG. 1 is not intended to provide an exhaustive or complete illustration of every possible embodiment of the Query Optimizer as described throughout this document.

In addition, it should be noted that any boxes and interconnections between boxes that may be represented by broken or dashed lines in FIG. 1 represent alternate embodiments of the Query Optimizer described herein, and that any or all of these alternate embodiments, as described below, may be used in combination with other alternate embodiments that are described throughout this document.

In the most general sense, the Query Optimizer 100 illustrated by FIG. 1, uses a physical plan, i.e., a query graph representation of a DSMS CQ (see Section 2.2.1), and an operator placement (i.e., operator node assignments) in combination with various statistics to produce an MAO cost estimate for the CQ in the DSMS. In various embodiments, iterative estimates of the MAO are used to select the best physical plan and/or optimize the operator placement to minimize worst-case latency. More specifically, the processes enabled by the Query Optimizer 100 begin operation by using a stimulus time scheduling module 105 to schedule events arriving at a source operator of a DSMS 110 from outside the DSMS (see Section 2.3.4 for a detailed discussion of stimulus time scheduling).

A statistics collection module 115 then collects statistics such as selectivity and input event rates as inputs from the DSMS 110 (see Section 2.3.2 for a definition and discussion of these statistics). A DLTS computation module 120 then uses these statistics to compute a deterministic load time-series (DLTS) (see section 2.3.3) for each of the nodes of the DSMS 110 over a set of temporal subintervals. In general, temporal subintervals represent equal-width segments of time over the period being evaluated (see Section 2.3.1 for a discussion of temporal subintervals).

The DLTS computation module 120 then passes the computed DLTS to a cost estimation module 125 that uses a query graph representation of the DSMS 110 in combination with a current operator placement to compute the MAO 130 for each node. Note that the worst-case MAO (i.e., MAO_{wc}) represents the maximum MAO for any single node of the query graph. See Section 2.4 for a detailed definition and discussion of MAO and Section 2.6 for a discussion of implementing MAO in a DSMS. Note also that query graphs are specifically defined in Section 2.2.1.

With respect to the current operator placement, this information is provided to the cost estimation module 125 by a query graph node assignment module 135 that assigns each operator to an individual node of the query graph of the DSMS 110. In general, the query graph node assignment module 135 receives the current operator placement from any of a number of sources, as shown by FIG. 1. For example, in the case that the Query Optimizer 100 is acting to optimize operator placement, a hill-climbing module 140 uses an iterative technique to find an operator placement that minimizes MAO, which also serves to minimize worst-case system latency. See Section 2.7.1 for a detailed discussion of hill-climbing techniques for operator placement. Further, while the hill-climbing module 140 can begin minimization or optimization of MAO using an initial random operator placement, initial operator placements can also be provided by a number of other sources.

For example, in various embodiments, a plan selection module 145 selects the best physical plan from the space of equivalent physical plans for a user-specified query. The plan selection provided via the plan selection module 145 is used to minimize MAO, which also serves to minimize worst-case system latency. Note that in various embodiments, the plan selection module 145 also allows the user to select or otherwise define an initial or desired physical plan from the space of equivalent physical plans. Further, in various embodiments, the plan selection module 145 interacts with an operator placement module 150 that generally defines all operator placements across all nodes. In a related embodiment, the operator placement module 150 specifies an initial or desired placement of individual operators on individual nodes.

Further, in various embodiments, an admission control module 155 allows the Query Optimizer to determine the effects of adding or removing one or more operators from the DSMS. As discussed in further detail in Section 2.1.3 and Section 2.7.3, admission control allows the Query Optimizer to decide whether adding a new CQ will violate some specified worst-case latency constraint, or how the removal of one or more CQs will improve worst-case latency.

In another embodiment, a system provisioning module 160 allows the Query Optimizer to predict the effect (on latency) of potential changes involving the availability of CPU cycles or nodes without actually procuring the additional cycles/cores/machines a priori. In other words, the system provisioning module 160 is capable of answering questions such as what the effects on latencies will be if additional system capabilities are added (e.g., add additional servers, CPU cycles, bandwidth, etc.) or removed. See Section 2.1.4 and Section 2.7.3 for an additional discussion of the idea and implementation of system provisioning.

Finally, in yet another embodiment, a user reporting module 165 is used to direct the cost estimation module 125 to periodically, or on demand, compute the MAO based on the current set of physical plans and operator placements in combination with the most current statistics, to report worst-case latency estimates (based on MAO_{wc}) to the user. In other words, since the statistics may change over time based on a variety of factors such as load on the DSMS (due to number of users or other factors), network bandwidth, etc., it should be understood that MAO_{wc} for the current set of physical plans and operator placements may also change over time. Consequently, the user reporting module 165 provides a useful way for the user to understand their query behavior and/or direct the Query Optimizer to re-compute MAO_{wc} whenever desired. Note that the Query Optimizer may also automatically perform re-optimization when system statistics change significantly (e.g., by more than some threshold amount).

2.0 Operational Details of the Query Optimizer:

The above-described program modules are employed for implementing various embodiments of the Query Optimizer. As summarized above, the Query Optimizer provides various techniques for computing the MAO cost metric, which is approximately equivalent to worst-case latency in a typical DSMS. The following sections provide a detailed discussion of the operation of various embodiments of the Query Optimizer, and of exemplary methods for implementing the program modules described in Section 1 with respect to FIG. 1.

In particular, the following sections contain examples and operational details of various embodiments of the Query Optimizer, including: an introductory discussion of various optimization issues and solutions provided by the Query Optimizer; a discussion of general considerations and definitions used in providing a detailed description of the Query Optimizer; latency estimation in a DSMS; a formal definition of MAO; the approximate equivalence of MAO to maximum or worst-case latency; implementing MAO within a DSMS; various applications of the Query Optimizer using the MAO metric; extensions to various elements of the Query Optimizer, including handling multiple processors or cores, considering network bandwidth resources, non-additive load effects, and load splitting.

2.1 Introductory Discussion of Optimization Issues and Solutions:

By way of example, in a real-world streaming application, such as real-time targeted advertising, a DSMS typically runs complex CQs over user initiated URL click-streams. Here, each event may be a user click that navigates the browser from one page to another. Each event may also be associated with other information, such as user-specific demographic data. Such a system is often used to answer multiple real-time CQs whose results can be used to display user- or URL-tailored targeted Web advertisements, to report interesting real-time statistics to the user (e.g., “what is hot right now”), etc. Clearly, a fast DSMS response (i.e., low system latency) to incoming events is important in such a system to avoid stale decisions. Further, a response that is too slow may not be useful. As summarized below, the Query Optimizer successfully addresses these and other issues.

2.1.1 Discussion of Input Loads in a Typical DSMS:

For purposes of discussion, FIG. 2 is presented to provide an exemplary illustration of measured input loads for click-stream data for a generic advertisement delivery system over an extended period of time.

For example, FIG. 2 depicts measured input event rates seen in an event click-stream 200 that was derived using actual data collected on a prototype advertisement delivery system over a period of 84 days. There are several interesting points worth noting in FIG. 2. For example, system behavior (in terms of input event rate) can be seen to be relatively predictable over long periods of time (such as the marked 17-day period 210). Such predictability in a DSMS indicates that the DSMS can highly benefit from query optimization that produces a good set of query plans and/or assignments of operators to nodes. Unfortunately, even during the relatively stable period 210, there is a lot of short-term variation in event rates (e.g., due to diurnal trends). These variations make it difficult to estimate cost in a meaningful manner. On the other hand, there are periodic shifts (e.g., “re-optimization points” 220), where system characteristics change significantly, motivating the need for query re-optimization, updating estimates reported to users, and (potentially) re-provisioning the system for the increased load.

2.1.2 Stream Query Optimization:

As is well known to those skilled in the art, each of the CQs installed on a typical DSMS has multiple logically equivalent but different “physical plans” which consist of multiple streaming operators connected by queues of events. In addition, in a distributed DSMS, these operators may themselves be distributed amongst the available nodes (i.e., servers/machines) in different ways. Such physical plans are generally derived using common database techniques such as query rewriting, join reordering, filter and project pushing, as well as specialized techniques like operator substitution, operator fusing, etc.

Unfortunately, while different physical plans may be logically equivalent, logically equivalent plans may not be equivalent in terms of their effect on system latency. In other words, the order of operators for answering particular queries often directly affects overall latency. Consequently, the process of “plan selection” is performed to decide which set of physical plans is the “best choice” given the anticipated load conditions and the available processing hardware. In general, this problem can be considered as a search through the space of available physical plans to find the best plan. However, due to the long-running nature of CQs (e.g., days or months), actually running each plan to determine which plan is best is typically impractical.

To further complicate matters, suppose the DSMS is running on multiple nodes (i.e., individual computers or servers), having potentially different numbers of processing cores in each node, in a data center with high bandwidth and fast interconnect. In such cases (which are typical), at the time of optimization or re-optimization (see discussion of FIG. 2), the query optimization involves performing operator placement, i.e., choosing the “best” assignment of operators to nodes that minimizes latency (i.e., the best physical plan), without actually trying each possible physical plan (again due to the long running nature of the CQs). As described in further detail below, the Query Optimizer described herein is capable of quickly performing such tasks using the MAO computed by the Query Optimizer.

2.1.3 Admission Control & User Reporting:

There may often be specific user constraints on system behavior, such as CQ prioritization or maximum acceptable worst-case latencies for some or all CQs (e.g., a requirement that worst-case latencies for all CQs should not exceed 50 ms). Consequently, when a new query is added to the system, it is often important to first determine or estimate whether such constraints are likely to be violated. Fortunately, the MAO cost model described herein is both easy to compute and gives a number (in seconds or other desired unit of time) that directly corresponds to latency, so that it can be effectively used for admission control and user reporting, as described in further detail below.

2.1.4 System Provisioning:

Beyond the capability of comparing physical plans under the same system characteristics and enabling admission control tasks, in various embodiments, the Query Optimizer is further capable predicting the effect (on latency) of potential changes involving the availability of CPU cycles or nodes. This is a non-trivial extension because it is generally infeasible to try out new system loads without actually procuring the additional cycles/cores/machines a priori. In other words, the Query Optimizer is capable of answering questions such as what the effects on latencies will be if additional system capabilities are added (e.g., add additional servers, CPU cycles, bandwidth, etc.) or removed. Clearly, such system provisioning capabilities are quite useful in a DSMS, especially when paired with the admission control and query optimization (e.g., physical plan selection) capabilities of the Query Optimizer.

2.1.5 Summary of Various Advantages of the Query Optimizer:

In view of the above introductory discussion of optimization issues and solutions provided by the Query Optimizer, it is clear that the Query Optimizer provides a cost estimation technique and associated cost metric (i.e., MAO) for use in evaluating the quality of various system inputs (i.e., set of selected physical CQ plans and/or operator placements). MAO, as estimated or computed by the Query Optimizer, is a metric that is both easy and quick to compute without introducing significant additional complexity into the system.

Further, determination of MAO by the Query Optimizer depends on only a few estimated system statistics (e.g., operator selectivity and cycles/event in combination with an expected event arrival workload). In addition, since the MAO metric closely corresponds to worst-case CQ latency in a real-time DSMS, the Query Optimizer is capable of estimating the cost for any previously unseen input using knowledge of only pre-existing or measured input statistics, without actually needing to deploy particular physical plans or actually simulating the expected input.

Given these features of the Query Optimizer, it should be understood that the Query Optimizer, and the MAO metric produced by the Query Optimizer, can be easily integrated into virtually any existing DSMS for use in improving query optimization and related tasks for such systems

2.2 General Definitions and Considerations:

The following paragraphs provide a general discussion of many of the variables, symbols, terms and concepts that are used in providing a detailed description of various embodiments of the Query Optimizer. This discussion begins with Table 1, shown below, which provides an overview of many of the symbols used in the following discussion along with a brief description of those variables and reference to various locations in this document where the symbols are defined or discussed in further detail.

TABLE 1
Summary of Terminology and Symbols

| Symbol | Description | Reference |
|---|---|---|
| {N₁, . . . , Nₙ} | Set of nodes (machines) in the DSMS | Def. 1, Sec. 2.2.1 |
| {O₁, . . . , Oₘ} | Set of operators in the DSMS | Def. 1, Sec. 2.2.1 |
| Cᵢ | Available CPU cycles per time unit, on node Nᵢ | Def. 1, Sec. 2.2.1 |
| {t₁, . . . , t_{d}} | Division of time into segments | Sec. 2.3.1 |
| LAT_{1 . . . d} | Max. latency across events in each subinterval | Def. 4, Sec. 2.3.1 |
| LAT_{wc} | Worst-case latency in DSMS | Def. 4, Sec. 2.3.1 |
| σ_{j,1 . . . q} | Selectivity of operator Oⱼ, q^{th} input queue | Sec. 2.3.2 |
| ω_{j,1 . . . d} | Cycles/event imposed by operator Oⱼ, q^{th} input | Sec. 2.3.2 |
| l_{j,1 . . . d} | Deterministic Load Time-Series for operator Oⱼ | Def. 5, Sec. 2.3.3 |
| L_{j,1 . . . d} | Deterministic Load Time-Series for node Nᵢ | Def. 6, Sec. 2.3.3 |
| AO_{i,1 . . . d} | Accumulated Overload time-series for node Nᵢ | Def. 9, Sec. 2.4.2 |
| MAO_{1 . . . d} | Maximum Accumulated Overload time-series | Def. 10, Sec. 2.4.2 |
| MAO_{wc} | Worst-case Maximum Accumulated Overload | Def. 10, Sec. 2.4.2 |

2.2.1 DSMS Models and CQs:

In general, each CQ physical plan, similar to a database query plan, consists of a directed acyclic graph (DAG) of operators. Further, each CQ may have a number of equivalent physical plans (e.g., the same input produces the same output for each plan), each represented by a different DAG of operators, with each physical plan potentially having different effects on latency. Each operator consumes events from one or more input streams, performs computation, and produces new events to be output or placed on the input stream of other operators. Operators generate load on their host nodes by consuming CPU cycles. Note that for purposes of discussion, it is assumed that all nodes are located in a data center having one or more shared-nothing nodes with a high-bandwidth fast interconnect, and synchronized clocks. Note that as is well known to those skilled in the art, a “shared-nothing” architecture is a distributed computing architecture in which each node is independent and self-sufficient, and there is no single point of contention across the system. However, it is important to understand that nothing in this discussion precludes the use of more widely distributed nodes or data centers, and that shared-nothing architectures are discussed herein only for purposes of explanation.

Definition 1 (DSMS and Query Graph): A DSMS consists of a set of n nodes, N={N₁, N₂, . . . , N}, a set of m operators, O={O₁, O₂, . . . , Oₘ}, and a partitioning of the m operators into n disjoint subsets, S={S₁, . . . , Sₙ} such that Sᵢ is the set of operators assigned to node Nᵢ. The assignment of operators to nodes is called the operator placement. Note that each of the m operators may belong to a different CQ. The “query graph,” G, is a DAG over O where the roots of the graph are referred to as “sources,” and the leaves of the graph are referred to as “sinks.” Each node, Nᵢ, is assumed to have a total available CPU of Cᵢ cycles per time unit. Note that the Cᵢ will clearly vary with processor type, speed, and number of cores, with these elements also possibly varying from node to node. However, it is assumed that this information will either be readily available (e.g., machine/server specifications) or that it can be automatically determined using conventional techniques. Further, in various embodiments, Cᵢ can also be set to some user desired level below the actual capabilities of each node such that some reserve CPU capacity is maintained at one or more of the nodes.

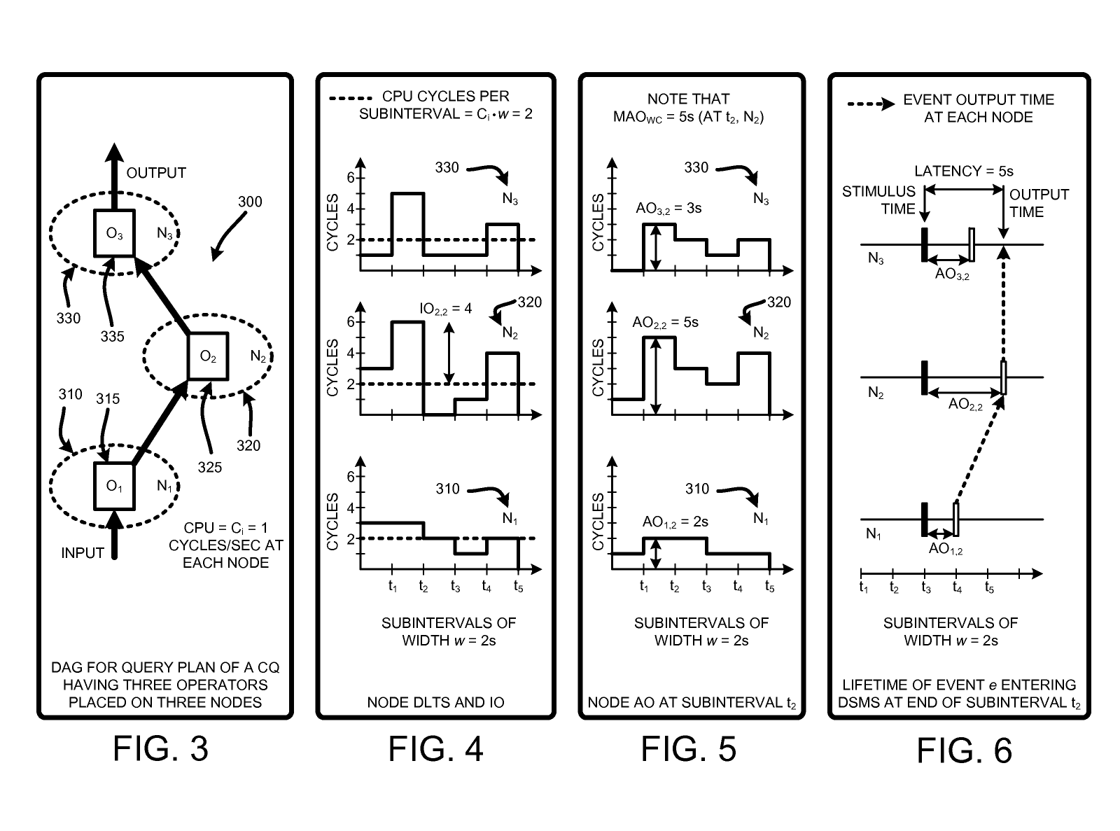

For example, FIG. 3 shows a simple DSMS query graph 300 with three nodes, N₁, N₂, and N₃ (310, 320, and 330, respectively), each having available CPU of Cᵢ cycles/second (where in this example Cᵢ=1 for purposes of explanation, though in a real node Cᵢ would typically be orders of magnitude larger). The partitioning in this example is Sᵢ={Oᵢ} ∀1≦i≦3. As such, the query graph illustrated by FIG. 3 contains three operators, O₁, O₂, and O₃ (315, 325, and 335, respectively), each placed on one of the three nodes (310, 320, and 330) in this simple example.

2.2.2 Latency:

For a typical real-time DSMS application, latency is a metric that is often of significant concern to users. In particular, users are generally concerned with the amount of delay that is introduced by the system from the point of event arrival to result generation. The following discussion distinguishes between two types of latencies:
1) “Information Latency”: Information latency refers to latency due to query semantics. For instance, when an aggregate receives input, the semantics of time windowing may not allow the aggregate to produce a result until some later event is received. This form of latency is not useful in evaluating the DSMS because it cannot be reduced by improving system performance.
2) “System Latency”: System latency refers to the time spent by events waiting in queues and being processed by operators. Each output event produced by the system at time t′ can be viewed as a response to some input stimulus event entering the system at time t. Consequently, system latency for a particular query is the time duration (t′−t) between when the stimulus (or input) enters the system and when the response (or output) exits the system.

System latency is a better measure of system behavior as compared to information latency because system latency is independent of query definitions and operator semantics, and directly relates to the performance of the DSMS. For instance, system latency for a CQ with a windowed aggregate operator is determined by only those input events that cause the operator to produce a result. Therefore, the remainder of the discussion of the Query Operator will focus on system latency (referred to simply as “latency” for the remainder of this discussion).

The term “worst-case latency” refers to worst-case system latency, which is used as the estimation target for the MAO metric computed by the Query Optimizer. Note that depending upon the operators associated with particular queries, each of those queries may exhibit different latencies (from initial input to result). Worst-case metrics are popular in applications with strict real-time requirements, since they provide an upper bound on system misbehavior, which can often be more useful than average measures. For example, in a stock trading application, users may never want to see results delayed by more than 30 seconds. It is also common practice in large systems to optimize for the worst-case or 99.9^{th} percentile rather than the average case. Note that other metrics such as throughput, bandwidth usage, reliability, and correctness may also be relevant for some applications. Any such metrics can be considered by the Query Optimizer when estimating MAO or using MAO for various purposes such as physical plan selection.

2.2.4 Assumptions:

The detailed description of the various embodiments of the Query Optimizer makes several assumptions, as discussed below. However, any or all of these assumptions may be lifted or modified, with some of the various implications of lifting these assumptions being discussed in Section 2.7.

Assumption 1: Deployment. It is assumed that the nodes of the DSMS are deployed in a low-latency and high-bandwidth, shared-nothing data center (cluster), and CPU is the main bottleneck. This is generally true for many streaming applications, including stream mining and complex event processing. Note that Section 2.7, provides additional discussion of extending the Query Optimizer to support other constrained resources such as network bandwidth.

Assumption 2: Temporal Correlation. It is assumed that past system behavior can be used as input to make predictions about future system behaviors and input levels. In various embodiments, this assumption is used to determine or report quality-of-service (QoS) predictions. It is also assumed that the selectivities and statistics are relatively stable in periods between query re-optimizations.

Assumption 3: Scheduling. It is assumed that that an operator scheduler runs on a single thread (per core) and schedules operators according to a particular scheduling policy (see Section 2.4 for additional discussion regarding this issue).

2.3 Latency Estimation in a DSMS:

The following paragraphs describe the general building blocks for implementing the cost estimation solution provided by the MAO. MAO is further defined and discussed in Section 2.4 to show the approximate equivalence of MAO to worst-case latency.

2.3.1 Handling Events Deterministically:

As a first step towards dealing with the complexity of a large and potentially distributed DSMS, it is useful to define a deterministic way of assigning events to points in time. Therefore, time is treated as discrete by dividing it into equal-width segments. More precisely, a time interval, [t₁,t_{d+1}), is partitioned into d discrete subintervals (or “buckets”), [t₁,t₂), . . . , [t_{d},t_{d+1}), each of width w time units. For purposes of explanation, a particular subinterval, [tₚ,tₚ₊₁), will be referred to herein simply by its left endpoint tₚ. Thus, time (τ) is represented as a set of subintervals where τ={t₁, . . . , t_{d}}. FIG. 4 shows an example set of subintervals, each of width w=2 seconds. Note that the total time period, τ, can either be predetermined, or can be dynamically adjustable.

More specifically, FIG. 4 illustrates a deterministic load time-series (DLTS) (see section 2.3.3) for each of the nodes, N₁, N₂, and N₃ (310, 320, and 330, respectively) of the DSMS query graph of FIG. 3 over five subintervals (i.e., where τ={t₁, . . . , t₅}). Expanding on the example of FIG. 3, in the example provided by FIG. 4, the subinterval width is again w=2 secs and CPU on each node is again Cᵢ=1 cycle/sec. Note that FIG. 4 is discussed in further detail in Section 2.4.1 with respect to the definition of “instantaneous overload” (IO).

Definition 2 (Stimulus Time): As discussed in further detail in Section 2.3.4, each incoming event is assigned a unique stimulus time, which represents the wall-clock time of its arrival at a source operator from outside. The stimulus time of an event produced by an operator Oⱼ is the stimulus time of the input event that triggered this event to be produced by Oⱼ. Note that operators receive events, from either outside the DSMS or from other operators, and generate events in response to processing of the received events.

Thus, stimulus times of events produced by operators are set to the stimulus time of the associated original incoming event, regardless of the actual time that the new event is produced. An event with stimulus time tε[tₚ,tₚ₊₁) is said to belong to subinterval tₚ. Note that each incoming event (and its “child events” spawned by operators) belongs to a unique subinterval.

In other words, in order to schedule events for execution by the corresponding operators on particular nodes, stimulus time scheduling first attaches the event arrival time (i.e., the actual or wall-clock time, synchronized to some reasonable level of accuracy between nodes) to events entering the system. Operators then propagate events through the query graph, while retaining the original timestamp on each event, even when an event crosses machine or node boundaries. As such, the scheduling policy provided by stimulus time scheduling selects the operator with the lowest event arrival time. Any other selection can be shown to increase worst-case latency. Given these definitions, latency and maximum latency are specifically defined, as discussed below. Note that there are various exceptions to this basic scheduling policy with respect to cases such as operator batching and operator priority as discussed in detail in Section 2.6.1.

Definition 3 (Latency): For each output event produced by a sink in query graph G, its latency is the difference between the sink execution time (i.e., the time of its output) and the stimulus time (i.e., the wall-clock time of the event's arrival at the source or first operator in the query graph. Note that this definition is equivalent to that of system latency in Section 2.2.2.

Definition 4 (Maximum Latency): Maximum latency is a time-series LAT_{1 . . . d} defined over the set of discrete subintervals. The maximum latency LATₚ for subinterval tₚ is the maximum latency across all output events which belong to subinterval tₚ, i.e., whose stimulus times lie in tₚ. The overall worst-case latency LAT_{wc} is simply the maximum latency seen over the entire time period. More formally, LAT_{wc}=maxₜ_{ₚ}_{ετ} LATₚ. In other words, LAT_{wc} is the highest latency of any event in the system.

2.3.2 Modeling Operators:

As discussed in Section 2.1, the overall system model is kept as simple as possible by using as few parameters as possible for input. In fact, testing of various embodiments have demonstrated that an acceptable solution to the problem of estimating or computing MAO can be achieved by maintaining as few as two parameters per operator Oⱼ, as defined below, though additional parameters may also be considered if desired.
a. Selectivity (σⱼ): This is the average number of events generated by the operator in response to each input event to the operator; and
b. Cycles/Event (ωⱼ): This is the average number of CPU cycles consumed by the operator for each input event to the operator.

In case of operators with q inputs, these parameters are maintained separately for each input, as σ_{j,1 . . . q} and ω_{j,1 . . . q}. In general, it is expected that these parameters will not change significantly between re-optimization points (see discussion of FIG. 2 in Section 2.1.1). This is an intuitively reasonable assumption, which has been validated exhaustively on real data and queries using tested embodiments of then Query Optimizer described herein.

2.3.3 Handling Load Deterministically:

The input (from outside sources) to a DSMS is one or more streams of events, each with time-varying event rates. In particular, the “event arrival time-series” of stream Z is a time-series whose value at each subinterval tₚ is simply the number of Z events belonging to subinterval tₚ. The event arrival time-series may be known in advance, or can be easily estimated using observed data, e.g., during periods of approximately repeatable load between query re-optimizations (as discussed with respect to FIG. 2).

The actual load imposed by operators during DSMS execution is difficult to model accurately because it is highly dependent on various factors including actual queue lengths, scheduling decisions, and runtime conditions. For example, the introduction of a new query into the DSMS can change the actual load time-series imposed by existing operators. This dynamic and hard-to-control nature makes maintaining them or using them to provide hard guarantees difficult. Moreover, such variability and system dependence makes it more difficult to estimate latency directly. Therefore, the Query Optimizer adopts an alternate definition referred to herein as “deterministic load time-series” (DLTS), as given below by Definition 5. Note that the following definition not only makes computation of MAO (see Section 2.4) easier, but it can also be used to prove the approximate equivalence of the MAO cost metric to actual latency.

Definition 5 (Operator DLTS): The DLTS of an operator Oⱼ is a time-series l_{j,1 . . . d} whose value l_{j,p} at each subinterval tₚετ equals the total CPU cycles required to process exactly all input events to Oⱼ that belong to subinterval tₚ.

Note that the DLTS of an operator can be viewed as the load imposed on the DSMS by the operator assuming “perfect” upstream behavior, i.e., assuming that all upstream operators process events and produce results “instantaneously” (i.e., the upstream operator will begin to process the event as soon as it is received). In practice, the time series l_{j,p} can be regarded as the product of: (1) the cycles/event parameter (ωⱼ), and (2) the number of input events to Oⱼ whose stimulus times lies in the subinterval tₚ. Thus, it is important to note that operator DLTS is independent of runtime system behavior. Given these points, DLTS for a node is defined as provided by Definition 6.

Definition 6 (Node DLTS): The DLTS of a node refers to the total load imposed by all the operators on the node. Therefore, the DLTS of a node Nᵢ is a time-series L_{i,1 . . . d}, whose value L_{i,p} at each subinterval tₚ is the sum of the load (at tₚ) of all operators assigned to that node. More formally, L_{i,p}=Σ_{O}_{ⱼ}_{εS}_{ᵢ}l_{j,p}. Note that more complex extensions to the general definition of DLTS provided above are discussed in Section 2.8. For example, as can be seen in FIG. 4, which illustrates the DLTS time-series graphs for three nodes, N₁, N₂, and N₃ (310, 320, and 330, respectively) in case of node N₂, it can be seen that L_{2,1}=3, L_{2,2}=6, L_{2,3}=0, and so on.

2.3.4 Stimulus Time Scheduling:

In general, as is well known to those skilled in the art, a DSMS typically has one scheduler per core that schedules operators to process events according to some policy. For example, the scheduler may maintain a list of operators with non-empty queues and use heuristics like round-robin or longest-queue-first to schedule operators for execution. Note that either more or fewer schedulers per core can be used, as desired.

In various embodiments of the Query Optimizer, an “operator scheduling policy” referred to herein as “stimulus time scheduling” is used for operator scheduling. The basic idea of stimulus time scheduling is that each operator is assigned a priority based on the earliest stimulus time amongst all events in its input queue. The scheduler then chooses to execute the operator having the event with earliest stimulus time. Note however, that in various embodiments, one or more operators associated with one or more particular CQs may be assigned a special priority that ensures the corresponding operators are executed first (or last, or in some specified order or sequence) regardless of the actual stimulus times associated with the corresponding events.

More specifically, with stimulus time scheduling, each node Nᵢ may execute one operator from Sᵢ at a time, and has a scheduler that schedules operators amongst Sᵢ for execution according to stimulus time scheduling. Consequently, at any given moment, the executing operator is processing the event with earliest stimulus time amongst all input events to operators in Sᵢ. However, it should also be noted that, in various embodiments of the Query Optimizer, individual schedulers may be used to address more than one core or node, if desired. Further, it should also be understood that prioritization of particular queries or batching considerations may cause the schedulers to use make occasional exceptions to strict stimulus scheduling, as discussed in further detail in Section 2.6.1.

Stimulus time scheduling ensures that the events that have older stimuli get priority over events with newer stimuli. In addition to being important to a provable guarantee of MAO's approximate equivalence to latency, this is also a reasonable scheduling policy, and is an improvement (in terms of latency) over the conventional round robin based approaches typically used in many conventional DSMS. Finally, since stimulus times become deterministic at the point of entry into the system (i.e. wall clock time with an assumption of synchronized or known time offsets at each node), scheduling is no longer dependent on dynamic runtime parameters like queue lengths.

For example, on a single node DSMS, stimulus time scheduling provides an optimal scheduling policy to minimize worst-case latency. In particular, at any given time t, an event with stimulus time t′ has already incurred a latency of t′−t. Thus, the event (e.g., event “e”) with earliest stimulus time is the one with highest as-yet incurred latency. Scheduling any event other than e only serves to increase the total latency of e, and hence the worst-case system latency.

2.4 Maximum Accumulated Overload (MAO):

The following discussion provides two candidate cost metrics for a DSMS. The first metric, as discussed in Section 2.4.1, is a strawman metric based on hypothetical instantaneous behavior. This strawman metric, referred to as “instantaneous overload” is used to discuss various advantages of the second metric, MAO. As described in Section 2.4.2, MAO specifically considers historical behavior of the DSMS (relative to the aforementioned statistics). MAO, in combination with DLTS and stimulus time scheduling, has been observed to provide a good cost basis for use as an accurate estimate of latency in tested embodiments of the Query Optimizer.

2.4.1 Strawman Metric: Instantaneous Overload:

Ideally, operators will be assigned to nodes such that none of the nodes in the system will be overloaded (i.e., a node that cannot keep up with the input to the operators hosted on each node). Such a placement guarantees that stream events will be processed “immediately” on arrival and will not spend time waiting in queues of overloaded operators. This behavior is captured by the notion of “instantaneous overload” (IO), i.e., by how much the load imposed on the node by the operators at each moment in time exceeds the available CPU capacity of the node, as formalized by Definition 8.

Note that it will not always be possible in real-world systems to guarantee that no node is ever overloaded. However, for many applications (e.g., a service for filtering and dissemination of news to users), such performance guarantees are not generally considered necessary, since a delay on the order of seconds or minutes is not typically considered to be highly relevant in such cases. Instead, one would like to guarantee that the system can keep up with the input streams over time. In other words, some processing nodes might temporarily fall behind during a load spike, but eventually they will catch up and process all their input events.

Definition 8 (IO): Instantaneous Overload (IO) of a node Nᵢ is a time-series IO_{i,1 . . . d} whose value IO_{i,p} at each subinterval tₚ is the difference between the load on the node and the available CPU for that subinterval. Using DLTS for node load, this gives IO_{i,p}=L_{i,p}−Cᵢ·w.

As discussed previously, FIG. 4 shows the DLTS for nodes, N₁, N₂, and N₃ (310, 320, and 330, respectively), with the IO at interval t₂ for node N₂ illustrated for purposes of explanation. For example, in case of node N₂, it can be seen that IO_{2,1}=L_{2,1}−Cᵢ·w=3−2=1, while IO_{2,2}=L_{2,2}−Cᵢ·w=6−2=4 (as illustrated by FIG. 4). Thus, one simple metric is the maximum IO across all nodes and time subintervals, which in the case of node N₂ as shown FIG. 4 is a value of “4”. A lower value of this metric is intuitively better, and this metric serves an interesting starting point. Unfortunately, like many other such metrics used in conventional DSMS systems, IO cannot be shown to directly relate to actual latency.

2.4.2 Accumulated Overload:

IO, as defined above, does not take the effects of overload in the past into account. For example, an overload at some time in the past can cause events to accumulate in operator queues, causing significant delays in the future. Consequently, the Query Optimizer instead uses a metric referred to as “accumulated overload” (AO), which is intuitively highly correlated with latency. Accumulated overload of a node at some time instant t is defined as the amount of work that this node is “behind” at time t. For example, if a node with two-billion cycles per second CPU capacity (i.e., Cᵢ=2,000,000,000) has 10-billion cycles' worth of unprocessed events in operator queues, then it will need ≈5 seconds to process this “left over” work from previous input events before it can start processing newly arriving events. Of course, it could process newly arriving events earlier, but that would only worsen latency because older events are delayed even longer.

Definition 9 (AO): The Accumulated Overload (AO) of a node Nᵢ is a time-series AO_{i,1 . . . d} whose value AO_{i,p} at each subinterval tₚ is defined iteratively as follows:

AO_{i,0}=0

AO_{i,p}=max{0,AO_{i,p-1}+L_{i,p}−Cᵢ·w} ∀1≦p≦d

In other words, AO tracks the cumulative extra work, and is reset to 0 when there is no overload. Note that DLTS, as defined above, is used to compute AO. FIG. 4 and FIG. 5 illustrate the relationship between node DLTS, CPU capacity, and AO for the previously discussed three node example illustrated by FIG. 3. For example, assuming that Cᵢ=1 for each node, then for N₂, AO_{2,1}=AO_{2,0}+L_{2,1}−C₂=0+3−2=1, while AO_{2,2}=AO_{2,1}+L_{2,2}−C₂=1+6−2=5. Thus, as illustrated by FIG. 5, AO for each of the nodes, N₁, N₂, and N₃ (310, 320, and 330, respectively), is AO_{1,2}=2, AO_{2,2}=5, and AO_{3,2}=3. Therefore, the worst-case AO (AO_{wc}) is 5 seconds (corresponding to AO_{2,2}). Given these definitions and considerations, the notion of maximum accumulated overload (MAO) is formalized by the following definition and discussion.

Definition 10 (MAO): MAO is a time-series, MAO_{1 . . . d}, whose value MAOₚ at each subinterval tₚ is the greatest accumulated overload (normalized by node CPU capacity) across all nodes for that subinterval. More formally, given this definition, MAOₚ=max_{N}_{ᵢ}_{εN}AO_{i,p}/Cᵢ. Therefore, the overall worst-case MAO (i.e., MAO_{wc}) is the greatest MAO across subintervals, i.e., MAO_{wc}=maxₜ_{ₚ}_{ετ}MAOₚ.

As illustrated by FIG. 5, it can be seen that the MAO time-series for the example setup shown is {MAO₁=1, MAO₂=5, MAO₃=3, MAO₄=2, MAO₅=4}, where MAO_{wc}=MAO₂=5. Thus, MAO_{wc} reflects the worst queuing delay due to unprocessed input events accumulating on a node. In fact, as discussed below in the simple example provided in Section 2.4.3, it can be seen that MAO_{wc}, computed using DLTS in a DSMS using stimulus time scheduling, is approximately equivalent to the actual worst-case latency LAT_{wc}.

2.4.3 Exemplary Comparison of MAO_{wc} to Worst-Case Latency:

Assume that there are three nodes (N₁, N₂, N₃) and three operators (O₁, O₂, O₃) in the DSMS (as illustrated by the example of FIG. 3), with each operator Oᵢ assigned to the corresponding node Nᵢ. Let the CPU capacity of each node be Cᵢ=1 cycle per second, and let the subinterval width, tₚ, be w=2 seconds. Thus, the available CPU at each subinterval is Cᵢ·w=2 cycles. The DLTS and AO of each node for this example are shown in FIG. 4 and FIG. 5.

Consider the subinterval t₂. As illustrated by FIG. 5, it can be seen that the AO for nodes N₁, N₂, and N₃ are 2, 5, and 3 seconds, respectively. Thus, N₂ has a maximum accumulated overload of MAO₂=AO_{2,2}=5 seconds. Therefore, if an event “e” arrives from outside at the end of subinterval t₂ (i.e., the current stimulus time is t₃ since subintervals are referred to by their left endpoints). FIG. 6 illustrates the progress of event e through the operators of N₁, N₂, and N₃. In view of the above example, consider the following two phases (i.e., upstream and downstream of Node N₂):

Node N₂ and Upstream Node N₁: Since AO_{2,2}≧AO_{*,2}, event e will be processed at N₁ and reach N₂ at time t₃+AO_{1,2} (or at time ≦t₃+AO_{2,2} if there were more nodes further upstream). By using the above defined stimulus time scheduling, it is known that as long as event e reaches N₂ at or before t₃+AO_{2,2}, it will be processed at N₂ at time t₃+AO_{2,2}=t₃+5. This is because scheduling depends only on the stimulus time of event e, and not the time when e actually reaches N₂.

Node N₂ and downstream Node N₃: Since AO_{2,2}≧AO_{*,2}, event e will be processed at N₂ and reach N₃ at time t₃+AO_{2,2}=t₃+5. At N₃ (and further downstream nodes if any), this event is guaranteed to have the earliest stimulus time (because AO_{2,2} is the maximum AO, as discussed above). Therefore, by using stimulus time scheduling, event e will be processed at N₃ “immediately” and thus e will be output at time t₃+AO_{2,2}=t₃+5. Consequently, it can be seen that the worst-case latency (i.e., LAT_{wc}) of event e is 5 seconds, which in this example corresponds exactly to AO_{2,2} and MAO_{wc}. Experiments with tested embodiments of the Query Optimizer have demonstrated this equivalency of MAO to latency to within a small margin of error on the order of about 4%. In other words, as discussed throughout this document, MAO_{wc}≅LAT_{wc}.

FIG. 3, described previously, can also be used to provide another example of the concept of MAO. In particular, assume for purposes of explanation that the MAO at each node (310, 320, and 330) is 4 s, 5 s, and 3 s, respectively. In other words, assume that for N₁, MAO=4, for N₂, MAO=5, and that for N₃, MAO=3. Since DLTS is used to derive AO time-series (see Section 2.4.2) an event that enters the DSMS at some particular time will get processed after 5 seconds, regardless of when it gets processed upstream, since for N₂, MAO=5 in this example.

More specifically, in this example, an event would wait 4 seconds at N₁'s queue. However, this means that it will wait only 1 sec at N₂, for a total of 5 seconds. Note that whatever time (<5 seconds) that the event arrives at N₂, it would still be processed at the 5 second mark (when using stimulus time scheduling). Further, newer events arriving at N₂ due to other data sources will not affect this due to the use of stimulus time scheduling as discussed in Section 2.3.4. In this example, if MAO at N₃ is improved, it will reduce time spent in queues at N₃ but this will only cause events to instead queue up at N₂ for longer periods of time, keeping the worst-case latency at 5 seconds.

Considering this example in another context, any event arriving “instantly” at N₁ would wait 3 seconds before being processed by the operator at that node. However, if that same event were to reach N₁ 5 seconds later, at that time it would be processed “instantly” since it would have the lowest arrival time and would be scheduled immediately due to the use of stimulus time scheduling. In effect, the event would spend zero time at N₁, and 5 seconds at N₂. Thus, even if the MAO at N₁ is improved, there is still no question of reducing the time spent at N₁ in this example. Again, as noted above, the term “instantly”, when referring to processing of events at nodes, means that the corresponding operator will begin to process the event as soon as it is received at that node, with that processing requiring some finite amount of time to complete.

2.5 MAO's Approximate Equivalence to Maximum Latency:

As discussed above, the simple example provided in Section 2.4.3 illustrated the approximate equivalence of MAO_{wc} to LAT_{wc} when using DLTS and stimulus time based scheduling in a DSMS. This relationship is discussed in greater detail in the following paragraphs. In particular, consider the following assumptions:

Assumption 1: For purposes of explanation, assume that subinterval t₁=0 and that Cᵢ=1 ∀i (however, as noted above, Cᵢ can vary between nodes, and will generally be on the order of billions of cycles per second in a real-world node). Hence, using these exemplary parameters, all loads can be described directly in time units. During each subinterval, tₚ, a node can perform w units of work. An operator, Oⱼ, executes by reading an event from its input queue, then consuming time on the node, Nᵢ, where OⱼεSᵢ, and then producing an output.

Assumption 2: Assume that for each input source, within each subinterval, tₚ, events have an approximately constant inter-arrival time α, where the first event arrives at tₚ, and the last event (if there is more than one event in the subinterval) arrives at tₚ₊₁−α. In other words, a plurality of events can arrive at a particular node within a single subinterval, with the arrival time between those events being spaced by the approximately constant inter-arrival time, α, since α is smaller than a single subinterval, tₚ.

Assumption 3: Assume that within a particular subinterval, tₚ, each operator Oⱼ requires a constant amount of load (ω_{j,q} cycles) to process every event from its q^{th} input queue, which belongs to that subinterval.

Given the three assumptions described above, in the single node case, the most latent event e with stimulus time tₚ and latency LATₚ on node Nᵢ, it can be shown that 0≦LATₚ≦AO_{i,p-1}+L_{i,p}. Further, if AO_{i,p-1}+L_{i,p}−w>0, then AO_{i,p-1}+L_{i,p}−w≦LATₚ.

In particular, in the case of the lower bound, if AO_{i,p-1}+L_{i,p}−w>0, then the system will not have sufficient CPU capacity to fully process the input during tₚ. Therefore, the most latent event, if it arrived at the last possible instant during a particular subinterval, tₚ, could have as little latency as the amount of work left after tₚ is over. Note that this quantity corresponds to the overload at the previous subinterval (i.e., AO_{i,p-1}), plus the time to process the new load (L_{i,p}), minus the processing time (w) consumed during the current time interval.

Further, in the case of the upper bound, the worst-case latency of the most latent event is guaranteed to have a latency less than the latency it would have had if all input events belonging to tₚ arrived at tₚ. In this situation, the latency is determined by the time it takes to process the overload at the previous subinterval (AO_{i,p-1}), plus the time to process the new load (L_{i,p}).

Therefore, given a particular subinterval tₚ, an operator Oⱼ (the only operator running on node Nᵢ in this example), with q input queues and their associated load per event quantities (see Assumption 3 above) for that subinterval ω_{j,1 . . . q}, if the operators which feed and consume events from Oⱼ all reside on nodes with accumulated overload AO≧_{i,p}, then Oⱼ introduces at most Σ_{c=1 . . . q}ω_{j,c} additional latency to the most latent event belonging to tₚ. Note that this sum is a very small number, as the typical time for an operator to process an event is generally on the order of microseconds using conventional computing devices.

Consequently, because of the approximately constant inter-arrival time assumption (see discussion of the a parameter in Assumption 2 above), on an individual input stream basis, work associated with processing that input is equally spread across each time interval. If this work was scheduled to execute in a perfectly spread out fashion, no additional latency would be introduced by Oⱼ since:
1. Upstream operators (residing on nodes with accumulated overload ≧AO_{i,p}) would feed work to Oⱼ no faster than Oⱼ could process it; and
2. Downstream operators (also residing on nodes with accumulated overload ≧AO_{i,p}) would be unable to process their load faster than Oⱼ could deliver work.

However, because in various embodiments of the Query Optimizer, events are scheduled to execute at discrete times (i.e., stimulus time scheduling), and are assumed to fully utilize the processor while executing, events may not actually execute until a slightly later time than they would in the more continuous model described above. More specifically, in the worst case, each input other than the one with the most latent event might process an event just prior to the proper processing time for the most latent event (since tₚ represents an interval and not a discrete time). Each of these events would then monopolize the CPU while being processed, resulting in the upper and lower bounds discussed above.

More specifically, as discussed above, MAO_{wc}≈LAT_{wc}. Therefore, given a DSMS that executes the query graph G using stimulus time scheduling, and assuming that the clocks at all nodes are synchronized, then MAO_{wc}≦LAT_{wc}≦MAO_{wc}+w+ε, where ε is a small number. In other words, given a DSMS that executes a query graph G according to stimulus time scheduling, assuming synchronized clocks at all nodes, and assuming that LATₚ is the highest latency of any output with stimulus time tₚ, then MAOₚ≦LATₚ≦MAOₚ+w+ε. Note that while synchronization is not required by the Query Optimizer, in the case that clocks are not synchronized between nodes, it is expected that overall performance (i.e., LAT_{wc}) will be degraded relative to the case where node clocks are synchronized.

2.6 Implementing MAO in a DSMS:

As discussed above in Section 1.1, FIG. 1 provides an overview of a DSMS that has been modified to include the Query Optimizer's MAO cost estimation capabilities as a surrogate for worst-case latency. The following paragraphs discuss these modifications in further detail.

2.6.1 Stimulus Time Scheduling:

A DSMS scheduler typically runs on a single thread per CPU core, and chooses operators for execution on that core. Recall from Definition 2 (see Section 2.3.1) that each event is associated with a stimulus time. When an event enters the DSMS from outside, the current wall-clock time is attached or otherwise associated to the event as its stimulus time. When an operator receives an event with stimulus time t, any output produced by the operator as the immediate response to this event is also given a stimulus time of t. Further, it should be noted that stimulus times are retained without modification across machine boundaries.

One simple method of achieving stimulus time scheduling is to use “priority queues” (PQs) ordered by stimulus time (i.e., oldest t first) to implement event queues. This results in O(lgn) enqueue and dequeue operations, where n is the number of events in the queue. However, in various embodiments of the Query Optimizer, this cost is reduced to a constant using the techniques described below.

In particular, the cost of stimulus time scheduling is reduced to a constant by implementing event queues as a collection of k FIFO queues, where k is the number of unique paths from the queue (edge) to the sources in the query graph, G. Note that k is at most a small constant known at query plan compilation time. Event enqueue translates into an enqueue into the correct FIFO queue (based on the event's path), while event dequeue is similar to a k-way merge over the head elements of the k FIFO queues. Therefore, both the enqueue and dequeue are O(lgk) operations which can be achieved using small tree and min-heap operations respectively. Note that the number, k, of FIFO queues is generally less than the number, n, of events in the queue. Consequently, the cost, O(lgk), of implementing event queues as a collection of k FIFO queues is less than the cost, O(lgn), of using of PQs ordered by stimulus time to implement event queues. Correctness follows from the fact that operators process input in stimulus time order, causing each FIFO queue to be in stimulus time order.

In operation, the scheduler maintains a priority queue (ordered by earliest event stimulus time) of active operators with at least one event in their input queues. Then, when invoked, the scheduler operates to schedule the operator having the event with lowest stimulus time in its input queue. Note that strict stimulus time scheduling may be relaxed, if desired, to allow prioritization of specific CQs or batching of events within a small duration such as one or more subintervals. This modification allows the Query Optimizer to introduce batching without causing the latency estimate to diverge by a significant amount so long as the number of subintervals spanning the duration remains small.

2.6.2 Computing Statistics:

When computing statistics for use in estimating the MAO, the Query Optimizer first derives the external event arrival time-series; this can be obtained by observing event arrivals in the past or may be inferred based on models of expected input load distribution. Statistics are maintained for each operator Oⱼ in the query graph as follows:

Operator selectivity (σⱼ): As noted above, selectivity, σⱼ, represents the average number of events generated by the operator in response to each input event to the operator. Selectivity is measured by maintaining counters for the number of input and output events for each operator and using this information for computing averages.

Operator cycles/event (ωⱼ): As noted above, the cycles per event, ωⱼ, for each operator, represents an average number of CPU cycles consumed by each operator for each input event to the operator. This statistic is determined by measuring the time taken by each call to the operator and number of events processed during the call. Note that in various embodiments of the Query Optimizer, scheduling overhead (i.e., time required to determine stimulus time scheduling for each event) is also incorporated into the operator cost given by the ωⱼ statistic.

Note that these parameters are independent of the actual operator-node mapping and available node CPU, which makes them particularly suited to operator placement, system provisioning, and user reporting. Note that the issue of estimating operator parameters for unseen CQs for plan selection and admission control is discussed in further detail in Section 2.7.

2.6.3 Computing DLTS and MAO:

First, for purposes of explanation, assume that each operator has only one input queue. For each operator Oⱼ, in the input stimulus time-series A_{j,1 . . . d}, the value A_{j,p} at each subinterval tₚ is simply the number of input events to Oⱼ that belong to (i.e., have stimulus time in) subinterval tₚ. A_{j,1 . . . d} is computed in a bottom-up fashion starting from the source operators. For a source operator, Oₛ, the input stimulus time series, A_{s,1 . . . d}, is simply the corresponding external event arrival time-series. Thus, for an operator Oⱼ whose upstream parent operator is O′ⱼ, it can be shown that A_{j,1 . . . d}=A_{j′,1 . . . d}·σ′ⱼ.

Given these time series, the DLTS of any operator Oⱼ is then calculated as l_{j,1 . . . d}=A_{j,1 . . . d}·ωⱼ, where ωⱼ is the operator cycles/event, as discussed above. Once the DLTS for each operator has been computed, AO and MAO are easy to compute using a direct application of Definitions 6, 9 and 10 (see discussion in Sections 2.3.3 and 2.4.2). The overall complexity of these computations is O(d·m), where d is the number of subintervals and m is the number of operators. Thus, it can be seen MAO is efficiently computed using a small set of statistics. Note that in the case of an operator with multiple inputs, statistics are maintained for each input separately; a function (usually a linear combination) is used to derive the DLTS of the operator and the input stimulus time-series for its child operators.

Note that for purposes of explanation, the model presented above for computing the DLTS assumes linearity in both the output rate and CPU load relative to input rates for each operator (with simple averages being used for both σⱼ and ωⱼ in the linear case). However, an assumption of such linearity may be a poor choice for some operators (e.g., join operators can be quadratic). Consequently, in various embodiments of the Query Optimizer, more complex models involving non-linear terms are provided for computing the DLTS for various operators. Fortunately, since the Query Optimizer bases the fitting of these models using real-world input data, there is no risk of overfitting even fairly complex models.

More specifically, while the Query Optimizer typically uses linear functions to relate operator input size to output size and CPU load, this may be insufficient in a number of cases, depending upon operator characteristics. Therefore, in the more general case, the Query Optimizer uses operator-specific models with as many parameters as needed to fit the model for computing the DLTS for each operator. Note that such fitting problems are well-known to those skilled in the art of database relational operators, and simply requires the addition of new non-linear terms (e.g., quadratic terms for join) to the parametric cost model, along with sufficient data to fit these parameters using techniques like non-linear regression. Again, overfitting is not a problem since the Query Optimizer fits these parameters with much more data than the number of parameters.

For example, a 2-way join operator with input rates X and Y may use the following non-linear model:

Output Rate=A₁*X+A₂*Y+A₃*X*Y (for selectivity)

CPU Load=B₁*X+B₂*Y+B₃*X*Y

Given this simple non-linear model, the corresponding system statistics contain, for each subinterval, the input rates (X,Y), the measured output rate and the CPU load. These statistics are then used with conventional regression techniques to estimate the values of A₁, A₂, A₃, B₁, B₂, and B₃ in order to compute the DLTS for each operator. As explained above, once the DLTS has been computed, AO and MAO are easy to compute using a direct application of Definitions 6, 9 and 10. In view of this simple example, it should be understood that the generalization to more complex non-linear models for use with complex operators is accomplished by simply adopting well-known modeling and curve fitting techniques. Note also that a typical DSMS architecture provides ample data to perform curve fitting since such architectures are generally designed to perform periodic re-optimization.

2.7 Various Applications Enabled by the Query Optimizer:

As discussed above, the MAO estimate produced by the Query Optimizer is useful for a number of applications, including, for example, operator placement, plan selection, admission control, etc. The following paragraphs provide a discussion of some of these applications for purposes of explanation.

2.7.1 Operator Placement:

In general, when there is “cluster” of two or more nodes that are either locally or directly connected, or connected across a network such as the Internet, the purpose of operator placement in a typical DSMS is, given a query graph, G, to find an assignment of operators in G to nodes that minimizes a meaningful metric like worst-case latency. Based on the close relationship between MAO and LAT, as described herein, the Query Optimizer uses MAO to formulate operator placement as an optimization problem. In other words, the operator placement problem is addressed by finding an operator placement that minimizes MAO_{wc}. Note that similar problems can be formulated by using MAO to address other latency-based goals, e.g., find the operator placement that minimizes average or 99^{th} percentile (across time) of MAO. Note that operator placement is generally the dominant form of query optimization in a DSMS.

Parameter Estimation:

As noted in Section 2.6, both selectivity, σⱼ, and cycles/event, ωⱼ, are independent of the actual node each operator runs on. Therefore, the parameter estimates collected using the current operator placement can be used to re-optimize for a better placement as discussed in further detail in the following paragraphs.

Operator Placement is NP-Hard:

In general, vector scheduling deals with assigning m d-dimensional vectors (p₁, . . . , pₘ) of rational numbers (called jobs) to n machines. The vector scheduling optimization problem involves minimizing the greatest load assigned to any machine in any dimension.

In the context of the operator placement problem addressed by the Query Optimizer, the Query Optimizer considers a decision version of the problem, i.e., “Is there a scheduling solution such that no machine exceeds a given load threshold, referred to herein as “MaxLoad,” in any dimension?”. This decision problem is known to be NP-complete, and the corresponding optimization problem is NP-hard.

Similarly, it can be shown that operator placement to minimize MAO_{wc} is also NP-hard, by reduction from vector scheduling. In particular, each vector pⱼ maps directly to operator Oⱼ's DLTS l_{j,1 . . . d} (there are m operators), each of the n machines in the vector scheduling problem is mapped to a node in the operator placement problem, and the CPU capacity is set to MaxLoad. From a practical standpoint, the result is a quality guarantee for a simple probabilistic algorithm that initially assigns each operator uniformly at random to a node. This algorithm achieves an approximation ratio of

$$O ( \frac{ln ( d \cdot n )}{ln ln ( d \cdot n )} )$$

with high probability. It is very fast and performs well when the number of operators is much larger than the number of nodes (i.e., load per operator is small compared to CPU capacity). This random assignment is used as a starting point for the MAO-HC operator placement algorithm that is defined and described in the following paragraphs.

MAO-HC Operator Placement Algorithm:

In various embodiments, the Query Optimizer provides a placement algorithm, defined herein as the “MAO-HC” algorithm (where “HC” refers to a “hill climbing” optimization process), to directly perform operator placements in a way that minimizes worst-case latency in the DSMS. In general, MAO-HC applies the randomized placement algorithm described above to the operator placement problem to generate a progressively optimized solution that generally converges towards an optimized solution after some number of iterations (or one that is terminated following some user specified number of iterations or period of time).

More specifically, as illustrated by the pseudo-code of lines 4-9 of the MAO-HC algorithm illustrated in Table 2, the MAO-HC algorithm repeatedly performs randomly seeded hill-climbing until a time (or iteration) budget is exhausted or there is insignificant improvement after some desired number of iterations. The hill-climbing step (line 6 of the MAO-HC algorithm illustrated in Table 2) greedily transforms one operator placement to another, such that MAO_{wc} improves. In each step, an operator is removed from the current bottleneck node (i.e., the node that has the MAO_{wc}) and assigned to a different node. The operator whose removal results in the greatest reduction in MAO on the bottleneck node is then migrated to another node.

In particular, this operator is assigned to the target node that would have the lowest MAO after this operator is added there. The operator move is permitted only if the new MAO on the target node (after adding the operator) is less than the MAO on the bottleneck node before the move. Otherwise, the algorithm attempts to move the next-best operator from the bottleneck node, and so on. If no operator can be migrated away from the bottleneck node, no further improvements are possible, and hill-climbing terminates.

TABLE 2
MAO-HC Operator Placement Algorithm

| | |
|---|---|
| 1 MAO-HC (time - budget b) begin | |
| 2 s ← CurrentTime( ); | // optimization start time |
| 3 m ← ∞ | // maximum accumulated overload |

4 while CurrentTime( ) − s < b do
5 p ← random placement
6 Hill-climb p to local optimum
7 m′ ← MAO_{wc}(p)
8 if m′ < m then m ← m′
9 if insignificant improvement for many iterations then
break
10 return m
11 End

Runtime Complexity of the MAO-HC Algorithm:

Recall that as discussed above, there are m operators, n nodes, and d subintervals. In general, random placement has complexity O(m). The complexity of hill climbing depends on the number of successful operator migration steps. During each step, it costs O(n·d) to find the bottleneck node and the target node. In the worst case, the algorithm has to try all operators on the node, giving a total runtime complexity of O(m·n·d).

Advantages of the MAO-HC Operator Placement Algorithm

The MAO-HC operator placement algorithm described above has a number of advantageous properties, as summarized below:
Random assignment and hill-climbing steps are computationally very cheap, allowing the algorithm to produce initial solutions quickly and to improve these solutions rapidly.
Depending on resource availability, the MAO-HC operator placement algorithm can adaptively select an appropriate tradeoff between result quality and runtime.
Each iteration of random placement and hill-climbing can be executed in parallel on a different node. This makes MAO-HC suitable for a multi-processor or multi-core architecture to rapidly reach an optimum placement solution or physical plan.
The MAO-HC algorithm can easily adapt to heterogeneous clusters where nodes have different CPU resources. In this case, instead of placing operators uniformly at random, placement probabilities are weighted by the relative CPU capacity of a node.

2.7.2 Plan Selection Applications:

The idea behind plan selection is to choose the best physical plan for a given CQ. The following paragraphs describe the use of the Query Optimizer in plan selection applications.

Parameter Estimation:

When it is desired to evaluate a new physical plan for a CQ, there are two basic alternatives for parameter estimation. The first alternative is to adapt techniques used in traditional databases, such as building statistics on incoming event data and estimating operator parameters using knowledge of operator behavior. For example, the selectivity of a filter can be estimated by using collected statistics on the column being filtered. The second approach (feasible in streaming systems) is to actually run the new physical plan offline over a small subset of incoming data, and compute operator selectivity, σⱼ, and cycles/event, ωⱼ, using such a run.

In tested embodiments of the Query Optimizer, it was observed that the latter approach (i.e., run the new physical plan offline over a small subset of incoming data) works very well for plan selection when using even very small sample sizes on the order of less than 1% of the total events. However, it should be understood that any desired sample size can be used to compute operator selectivity, σⱼ, and cycles/event, ωⱼ, using test runs on subsets of collected data.

Navigating the Search Space:

Navigating the search space can use traditional schemes like branch-and-bound or dynamic programming. Standard techniques such as query rewriting, join reordering, predicate pushing (e.g., changing the location of a filter operator), operator substitution (e.g., replacing a specialized operator with a set of standard operators), operator fusing (eliminating the queue between two operators by logically merging their behavior), etc. can also be adapted for use by the Query Optimizer. In particular, after parameter estimation, the Query Optimizer can compute the quality of any plan (in terms of worst-case latency) by assuming a single node and computing MAO_{wc} using the technique described in Section 2.6, in time O(d·m). Note that while the best plan may actually depend to a limited extent on the operator placement, this concept is treated independently for purposes of explanation.

Note that due to the long-running nature of CQs and the potentially high reward of good plans (in terms of increased responsiveness to inputs/outputs relating to those CQs), a DSMS can adopt an aggressive iterative approach of periodic re-optimization, similar to techniques proposed for traditional databases. Re-optimization can be performed when the statistics have been detected to have changed significantly (or by more than some predetermined threshold), such as, for example, the “re-optimization points” 220 indicated in FIG. 2. It should also be understood that re-optimization can also be performed on demand, at one or more predetermined or user specified intervals, or whenever some trigger condition is met (e.g., number of users, observed latencies, bandwidth changes, etc.).

2.7.3 Admission Control Provisioning and User Reporting:

In general, the idea behind admission control is to decide whether adding a new CQ will violate some specified worst-case latency constraint. During plan selection, it is easy to check that the new MAO_{wc} satisfies the latency constraint (based on the approximate equivalence between MAO_{wc} and LAT_{wc}) before admitting the CQ into the DSMS. Note that the hill-climbing techniques described above can be used in combination with admission control to determine optimal operator placements (including reorganization of existing operator placements) when adding or removing operators. These operations are performed prior to adding or removing operators as part of the admission control process such that a manual or automated decision can be made regarding admission control for one or more operators based on the new MAO_{wc} that is estimated to result from the addition or removal of those operators.

System provisioning can be performed by taking the current set of physical plans and statistics, and using the techniques described in Section 2.6 to determine MAO_{wc}, and hence the benefit, of a new proposed set of nodes and CPU capacities. This works particularly well since the operator parameters (i.e., operator selectivity, σⱼ, and cycles/event, ωⱼ) are independent of placements and capacities. In other words, system provisioning involves the addition or removal of computer or network resources, with the Query Optimizer using the new (or proposed) resource allocations to estimate MAO_{wc} for the DSMS.

Finally, user reporting can operate periodically, or on demand, on the current set of plans and placements, to report worst-case latency estimates (based on MAO_{wc}) to the user.

2.8 Extensions to Various Embodiments of the Query Optimizer:

The following paragraphs describe several extensions to various embodiments of the Query Optimizer. Some of these extensions include using the Query Optimizer in an environment where individual nodes include multiple processors or cores, considering network bandwidth (and bottlenecks) in estimating MAO_{wc}, considering non-additive load effects, and load splitting (where an operator may be distributed across two or more modes which then each fractionally process that operator).

2.8.1 Handling Multiple Processors or Cores:

In general, the Query Optimizer will use one scheduler thread for each processor core on a machine (though one scheduler can handle multiple cores, if desired), with the operators being partitioned across the cores. Further, CPU (i.e., of Cᵢ cycles per time unit) is the primary resource being consumed by operators. Each scheduler can independently use stimulus time scheduling since the scenario of multiple processors or cores in a node is equivalent to that with multiple separate single-core nodes.

2.8.2 Taking Network Resources into Account:

The preceding discussion generally focused on data centers, where network resources are usually not a bottleneck. However, link capacity is just another resource that introduces latency due to queuing of events. Therefore, in network-constrained scenarios, link capacity can be treated like CPU (i.e., of Cᵢ cycles per time unit) by taking into account how load accumulates at network links when computing MAO.

Note, however, that hill-climbing for operator placement in MAO-HC is more complex when considering network resources, because moving operators from one node to another not only affects the CPU load, but also some network links. Further, if a network link is targeted by hill-climbing, link load reduction can only be accomplished by moving operators, resulting in changes to some nodes' CPU loads. These considerations are used in various embodiments of the hill-climbing step in the above-described MAO-HC operator placement algorithm to enable the Query Optimizer to perform the various tasks described herein for a DSMS running in network-constrained scenarios.

In other words, as with the various capabilities of the Query Optimizer described in the context of a DSMS running in a data center (e.g., MAO computation, and the use of MAO in applications such as query placement, provisioning, admission control, user reporting, etc.), the Query Optimizer is also capable of performing these same tasks in a network-constrained scenario. These capabilities are enabled by modifying the hill-climbing elements of the MAO to consider the link capacity in addition to the other factors described above.

2.8.3 Non-Additive Load Effects:

When co-locating operators on the same node, in one embodiment, the Query Optimizer simply adds their load time-series. However, this ignores caching effects of operators that access the same or very different data. Hence, the total load of a set of operators might not be a simple sum. Therefore, since the Query Optimizer does not use any specific properties of the load summation function in the problem formulation and algorithm described above, the summation function can be replaced by any desired function that combines load time series and takes cache effects and others into account. Similarly, it should also be understood that the Query Optimizer does not inherently require the CPU capacity of a node to be constant. Thus, if other processes use up CPU cycles, the constant CPU capacity function is simply replaced by a time-series similar to the load in order to model the CPU available for use by the operators.

2.8.4 Load Splitting:

In contrast to the embodiments described above where operators were described as being processed on individual nodes, in some cases, it is useful to replicate an operator on multiple nodes (two or more) and then have each replica process a fraction of the input. For instance, in the MAO-HC algorithm, if an expensive operator (on the bottleneck node) cannot be moved in its entirety to another node, it may be possible instead to split the operator and move one replica to a different node to reduce bottleneck MAO_{wc}.

For stateless operators, such splitting is straightforward. However, operator replication is more complicated for stateful operators (e.g. for joins, it is necessary to guarantee that all matching pairs are found). Fortunately, these issues are very similar to the issues that have already been solved in conventional parallel database applications. Consequently, conventional splitting techniques are applied in various embodiments of the Query Optimizer to achieve whatever load splitting is possible. Once splitting and operator replication have been done using conventional techniques, the Query Optimizer uses the techniques described herein to determine MAO for use in the various applications described herein. For example, if splitting is performed prior to optimization, the MAO-HC operator placement algorithm will automatically distribute the replicas (and any non-split operators) in a sensible way by treating them as individual operators. Note that in various embodiments, the query graph is then further simplified by merging replicated operators residing on the same node into one operator.

3.0 Operational Summary of the Query Optimizer:

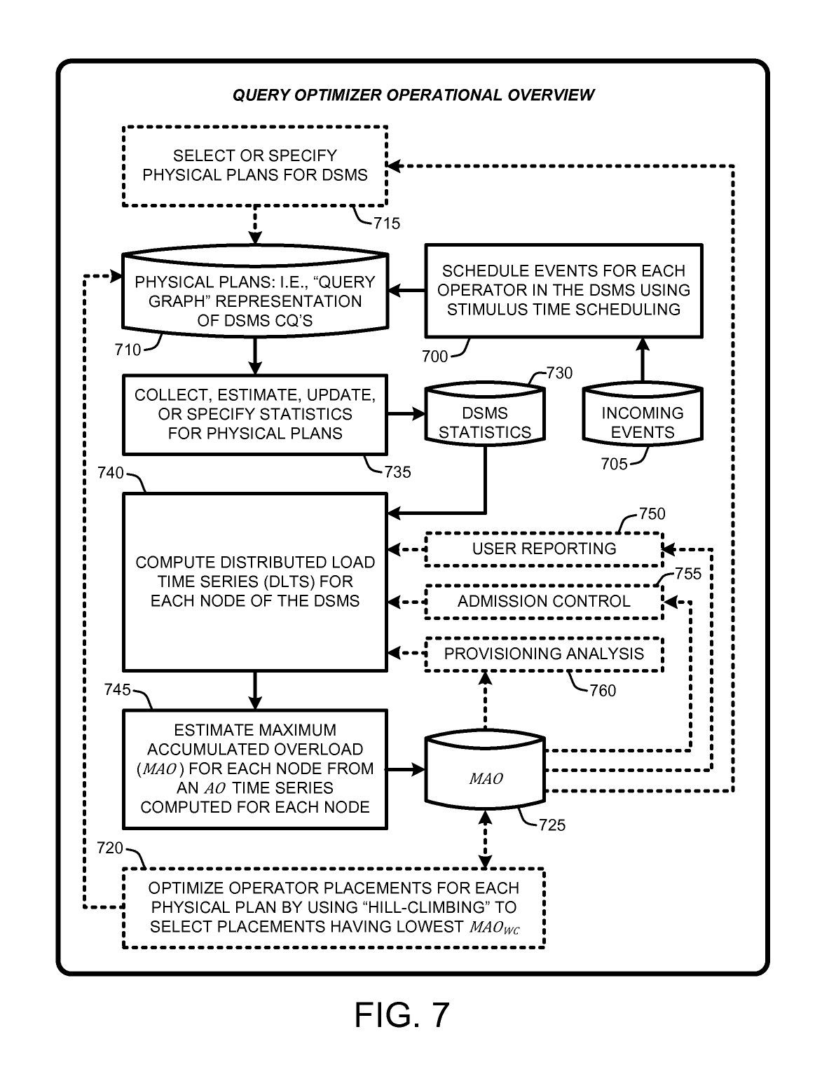

The processes described above with respect to FIG. 1 through FIG. 6, and in further view of the detailed description provided above in Sections 1 and 2 are illustrated by the general operational flow diagram of FIG. 7. In particular, FIG. 7 provides an exemplary operational flow diagram that summarizes the operation of some of the various embodiments of the Query Optimizer. The following summary is intended to be understood in view of the detailed description provided above in Sections 1 and 2.

Note that FIG. 7 is not intended to be an exhaustive representation of all of the various embodiments of the Query Optimizer described herein, and that the embodiments represented in FIG. 7 are provided only for purposes of explanation. Further, it should be noted that any boxes and interconnections between boxes that are represented by broken or dashed lines in FIG. 7 represent optional or alternate embodiments of the Query Optimizer described herein. Finally, any or all of these optional or alternate embodiments, as described below, may be used in combination with other alternate embodiments that are described throughout this document.

In general, as illustrated by FIG. 7, various embodiments of the Query Optimizer begin operation by scheduling 700 incoming events 705 for each operator of the physical plan corresponding to each CQ. As discussed above, each physical plan provides a “query graph” representation of a DSMS CQ (i.e., a directed acyclic graph of streaming operators of the CQ, as discussed above in Section 2.2.1). The scheduling 700 of events 705 is accomplished by using “stimulus time scheduling” (as discussed above in Section 2.3.4).

With respect to the physical plan, in various embodiments, that plan is either manually or automatically selected or specified 715, as discussed above. In general, automatic plan selection for each CQ is accomplished by iterating through the set of equivalent plans in the plan space for each CQ to choose the plan having the lowest MAO_{wc} for the corresponding CQ. Once the physical plan has been selected for a CQ, that physical plan is optimized 720 by determining the operator placement that results in the lowest MAO_{wc}. In various embodiments, this optimization 720 is accomplished using the above-described “hill-climbing” process.

More specifically, given any physical plan (whether selected 715 or optimized 720), the query optimizer uses a set of DSMS statistics 730 that are collected, estimated, updated or specified 735 based on the current physical plan 710. As discussed above in Section 2.3.2, these statistics include selectivity and input event rates.

Next, given the DSMS statistics 730, the query optimizer computes 740 the distributed load time series (DLTS) for each node of the DSMS. As discussed in Section 2.3.3, the DLTS is computed over equal-width subintervals of a predetermined time-period. However, it should be noted that, in various embodiments, this time-period can also vary dynamically, or can be set to any user specified value, if desired. Further, while not optimal, it should be understood that, if desired, the subintervals could vary in size rather than having a fixed width.

Given the DLTS for each node, the Query Optimizer then estimates 745 the maximum accumulated overload (MAO) 725 for each node. Again, as described throughout this document, the MAO 725 provides a surrogate for worst-case latency in the DSMS since the MAO is approximately equivalent to the worst-case latency.

Further, as discussed above, the ability to compute the MAO as a surrogate for worst-case latency enables a variety of applications, such as user reporting 750 (where the query optimizer is directed to compute MAO based on the current DSMS statistics 735), admission control 755 (where changes to MAO are used to determine whether a new CQ and its associated operators should be added to the DSMS 710), and a provisioning analysis 760 which determines what will happen to the MAO based on the addition or removal of one or more nodes or network resources from the DSMS.

4.0 Exemplary Operating Environments:

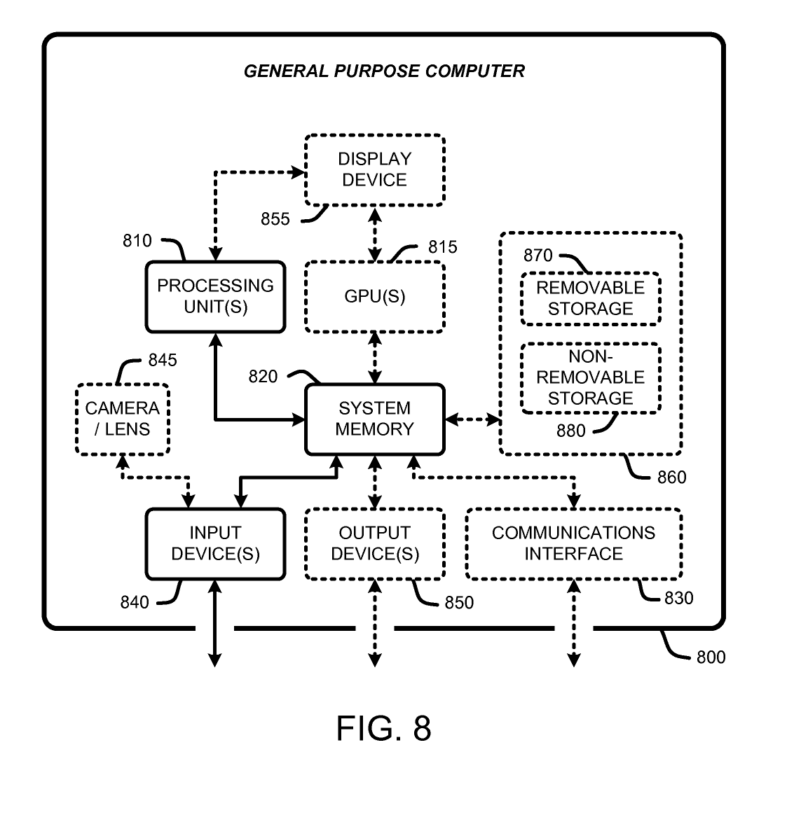

The Query Optimizer described herein is operational within numerous types of general purpose or special purpose computing system environments or configurations. FIG. 8 illustrates a simplified example of a general-purpose computer system on which various embodiments and elements of the Query Optimizer, as described herein, may be implemented. It should be noted that any boxes that are represented by broken or dashed lines in FIG. 8 represent alternate embodiments of the simplified computing device, and that any or all of these alternate embodiments, as described below, may be used in combination with other alternate embodiments that are described throughout this document.

For example, FIG. 8 shows a general system diagram showing a simplified computing device. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc. Note also that clusters of any of the aforementioned devices (either locally or directly connected or connected across a network such as the Internet) can also be used to provide the “computing nodes” for performing the techniques described herein with respect to the Query Optimizer.

To allow a device to implement the Query Optimizer, the device should have a sufficient computational capability to perform the various operations described herein. In particular, as illustrated by FIG. 8, the computational capability is generally illustrated by one or more processing unit(s) 810, and may also include one or more GPUs 815. Note that that the processing unit(s) 810 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 8 may also include other components, such as, for example, a communications interface 830. The simplified computing device of FIG. 8 may also include one or more conventional computer input devices 840. The simplified computing device of FIG. 8 may also include other optional components, such as, for example, one or more conventional computer output devices 850. Finally, the simplified computing device of FIG. 8 may also include storage 860 that is either removable 870 and/or non-removable 880. Note that typical communications interfaces 830, input devices 840, output devices 850, and storage devices 860 for general-purpose computers are well known to those skilled in the art, and will not be described in detail herein.

The foregoing description of the Query Optimizer has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Query Optimizer. It is intended that the scope of the invention be limited not by this detailed description, but rather by the claims appended hereto.

What is claimed is:

1. A method for estimating worst-case latency in a data stream management system (DSMS), comprising steps for:
receiving a set of physical plans corresponding to an individual continuous query for the DSMS, each of the physical plans defining a DAG of operators and an associated placement of these operators across one or more nodes of the DSMS;
receiving a set of statistics corresponding to a number of events generated by each operator in response to each input event to the operator, and a set of statistics corresponding to a number of CPU cycles consumed by each operator for each input event to the operator, said statistics being determined by using operator-specific models with as many parameters as needed to fit a model for computing a distributed load time series (DLTS) for each operator;
for each node, using the statistics for computing the DLTS for subintervals of a known time period;
using the DLTS for each node to estimate an accumulated overload (AO) time series for each node;
identifying a maximum accumulated overload (MAO) as the largest AO for each node; and
estimating a worst-case latency of the DSMS as corresponding to the largest MAO over all nodes of the DSMS.

2. The method of claim 1 wherein the DLTS of each node is a time-series whose value at each subinterval is determined based on the total CPU cycles required to process all input events to the operators on each node, said input events having stimulus times that lie within the corresponding subinterval.

3. The method of claim 1 wherein events entering the DSMS from outside the DSMS are scheduled for execution on a corresponding operator using a stimulus time scheduling policy.

4. The method of claim 3 wherein the stimulus time scheduling policy schedules events for execution by the corresponding operators on particular nodes by attaching an initial event arrival time to events entering the DSMS from outside the DSMS, with that event arrival time being maintained by corresponding events generated by each operator.

5. The method of claim 4 wherein the initial event arrival time of each event corresponds to a current “wall-clock” time at the moment of event arrival, and wherein the wall-clock time of each node is synchronized with each other node.

6. The method of claim 4 wherein events are processed from an event queue associated with each operator in order of earliest initial event arrival times, regardless of when they arrive in the queue of a particular operator.

7. The method of claim 1 further comprising performing an admission control analysis for automatically estimating a new largest MAO over all nodes of the DSMS resulting from the addition of one or more new continuous queries without actually adding the new continuous queries to the DSMS prior to the estimation of the new largest MAO.

8. The method of claim 1 further comprising performing a provisioning analysis for automatically estimating a new largest MAO over all nodes of the DSMS resulting from a change in a number of nodes of the DSMS without actually changing the number of nodes of the DSMS prior to the estimation of the new largest MAO.

9. The method of claim 1 wherein the physical plan for the DSMS is selected through an iterative process that converges on a physical plan that minimizes the largest MAO over all nodes of the DSMS.

10. The method of claim 9 wherein the selected physical plan is optimized by using an iterative process for determining a corresponding operator placement having a lowest worst-case MAO, said iterative process comprising:
performing an initial randomly seeded placement of one or more operators on each of the nodes;
identifying a bottleneck node as the node having the largest MAO over all nodes of the DSMS; and
identifying an operator on the bottleneck node whose removal from that node and placement on another node will result in the largest reduction in the MAO for the bottleneck node.

11. The method of claim 10 wherein the iterative process is repeated until a reduction in the largest MAO over all nodes of the DSMS is less than a predetermined threshold.

12. A system for optimizing latency-based operation of a data stream management system (DSMS), comprising using one or more computing devices for:
selecting a physical plan from each of a set of one or more physical plans corresponding to each of one or more continuous queries (CQs) for the DSMS, each physical plan defining a DAG of operators;
wherein each plan further includes an initial placement of corresponding operators on one or more corresponding nodes in a cluster of two or more nodes of the DSMS;
for each selected physical plan, generating a set of statistics corresponding to a total number of events output by each corresponding operator in response to each input event to the operator, and a set of statistics corresponding to a total number of CPU cycles consumed by each corresponding operator for each input event to that operator;
for each selected physical plan, using the statistics to compute a distributed load time series (DLTS) for subintervals of a known time period for each corresponding node, wherein the DLTS of each node is a time-series whose value at each subinterval is determined based on the total CPU cycles required to process all input events to the operators on each node, said input events having stimulus times that lie within the corresponding subinterval;
for each selected physical plan, using the DLTS for each node to estimate an accumulated overload (AO) time series for each corresponding node, wherein the AO time series for each node represents an estimate of time required to process all events waiting in corresponding operator event queues for each node;
for each selected physical plan, identifying a maximum accumulated overload (MAO) as the largest AO for each corresponding node;
for each selected physical plan, estimating a worst-case latency of the DSMS as corresponding to the largest MAO over all corresponding nodes of the DSMS; and
for each selected physical plan, using the initial placement of operators as a starting point for iteratively determining a new optimal placement of those operators on one or more corresponding nodes by iteratively repeating the estimation of the worst case latency to identify an operator placement that minimizes the estimated worst-case latency.

13. The system of claim 12 wherein events entering the DSMS from outside the DSMS are scheduled for execution on a corresponding operator using a stimulus time scheduling policy, comprising:
scheduling events for execution by the corresponding operators on particular nodes by attaching an initial event arrival time to events entering the DSMS from outside the DSMS, with that event arrival time being maintained by corresponding events generated by each operator;
wherein the initial event arrival time of each event corresponds to a current “wall-clock” time at the moment of event arrival, and wherein the wall-clock time of each node is synchronized with each other node; and
wherein events are processed from the corresponding event queue associated with each operator in order of earliest initial event arrival times, regardless of when they arrive in the event queue of a particular operator.

14. The system of claim 12 wherein selecting a physical plan from each of a set of one or more physical plans corresponding to each of one or more continuous queries (CQs) for the DSMS further comprises iteratively identifying a plan from each set that exhibits the smallest MAO of all plans in that set.

15. The system of claim 12 wherein the initial placement of corresponding operators is provided via a randomly seeded placement, and wherein iteratively determining a new optimal placement of operators for each selected plan further comprises performing an iterative process for:
identifying a bottleneck node as the node having the largest MAO over all corresponding nodes of the DSMS;
identifying an operator on the bottleneck node whose removal from that node and placement on another node will result in the largest reduction in the MAO for the bottleneck node; and
wherein the iterative process is repeated until a reduction in the largest MAO over all nodes of the DSMS is less than a predetermined threshold.

16. The system of claim 12 further comprising using one or more computing devices for performing an admission control analysis for automatically estimating a new largest MAO over all nodes of the DSMS resulting from the addition of one or more new continuous queries without actually adding the new continuous queries to the DSMS prior to the estimation of the new largest MAO.

17. The system of claim 12 further comprising using one or more computing devices for performing a provisioning analysis for automatically estimating a new largest MAO over all nodes of the DSMS resulting from a change in a number of nodes of the DSMS without actually changing the number of nodes of the DSMS prior to the estimation of the new largest MAO.

18. A computer-readable medium having computer executable instructions stored therein for minimizing worst-case latency of continuous queries in a data stream management system (DSMS), said instructions comprising:
receiving a set of alternate physical plans for the DSMS, each of the alternate physical plans corresponding to the same continuous query (CQ);
wherein each physical plan defines a query graph of operators corresponding to the CQ and an initial placement of those operators across one or more corresponding nodes of the DSMS;
for each physical plan, generating a set of statistics defining a number of events output by each operator in response to each input event to the operator, and a set of statistics defining a number of CPU cycles consumed by each operator for each input event to that operator;
for each physical plan, using the statistics to compute a distributed load time series (DLTS) for subintervals of a known time period for each corresponding node, wherein the DLTS of each corresponding node is a time-series whose value at each subinterval is determined by the total CPU cycles required to process all input events to the operators on each corresponding node, said input events having stimulus times that lie within the corresponding subinterval;
for each physical plan, using the DLTS for each node to estimate an accumulated overload (AO) time series for each corresponding node, wherein the AO time series for each corresponding node represents an estimate of time required to process all events waiting in corresponding operator event queues for each corresponding node;
for each physical plan, using the AO time series for each node to estimate a worst-case latency for any corresponding node in the DSMS; and
selecting the physical plan having the lowest estimated worst-case latency for use in the DSMS, thereby minimizing worst-case latency of the CQ in the DSMS.

19. The computer-readable medium of claim 18 wherein events entering the DSMS from outside the DSMS are scheduled for execution on a corresponding operator using a stimulus time scheduling policy, comprising:
scheduling events for execution by the corresponding operators on particular nodes by attaching an initial event arrival time to events entering the DSMS from outside the DSMS, with that event arrival time being maintained by corresponding events generated by each operator;
wherein the initial event arrival time of each event corresponds to a current “wall-clock” time at the moment of event arrival, and wherein the wall-clock time of each node is synchronized with each other node; and
wherein events are processed from the corresponding event queue associated with each operator in order of earliest initial event arrival times, regardless of when they arrive in the event queue of a particular operator.

20. The computer-readable medium of claim 18 further comprising iteratively identifying a new optimal placement of the operators across two or more corresponding nodes of the DSMS using computer executable instructions comprising:
identifying a bottleneck node as the node having the largest estimated worst-case latency over all corresponding nodes of the DSMS;
identifying an operator on the bottleneck node whose removal from that node and placement on another node will result in the largest reduction in the estimated worst-case latency for the bottleneck node; and
wherein the iterative process is repeated until a reduction in the largest estimated worst-case latency over all nodes of the DSMS is less than a predetermined threshold.
